(19) United States
(12) Patent Application Publication
(10) Pub. No.: US 2018/0204201 A1
(43) Pub. Date: Jul. 19, 2018

(54) METHOD, APPARATUS, AND COMPUTER-READABLE MEDIUM FOR RANKING MESSAGES IN A SOCIAL NETWORK BASED ON A VIRTUAL CURRENCY

(71) Applicant: Skale Company, Pittsburgh, PA (US)

(72) Inventors: Alexander R.W. Cheek, Pittsburgh, PA (US); Nathaniel Cabot Earle, JR., Pittsburgh, PA (US)

(21) Appl. No.: 15/872,295

(22) Filed: Jan. 16, 2018

Related U.S. Application Data
(60) Provisional application No. 62/446,073, filed on Jan. 13, 2017.

(51) Int. Cl. G06Q 20/22; G06Q 50/00; G06Q 20/40; G06Q 20/06

(52) U.S. Cl. CPC G06Q 20/223; G06Q 50/01; G06F 17/3028; G06Q 20/065; G06Q 20/405

(57) ABSTRACT

An apparatus, computer-readable medium, and method for ranking messages in a social network based on a virtual currency, including receiving an indication of approval over the social network for a message posted on the social network from a first user of the social network, the indication of approval being associated with a quantity of virtual currency and the quantity of virtual currency being less than or equal to a balance of virtual currency in a first account of the first user on the social network, transforming metadata associated with the message to increment a count of virtual currency associated with the message by the quantity of virtual currency associated with the indication of approval, the social network being configured to rank one or more messages posted on the social network based at least in part on a quantity of virtual currency associated with each message in the one or more messages, and removing the quantity of virtual currency from the first account of the first user.

### RELATED APPLICATION DATA

This application claims priority to U.S. Provisional Application No. 62/446,073, filed Jan. 13, 2017, the disclosure of which is hereby incorporated by reference in its entirety.

### BACKGROUND

Many social media platforms allow users to express approval for content posted or created by other users. For example, Facebook™ allows users to “like” other users' posts and Twitter™ allows users to retweet or favorite other users' tweets.

However, in current social media systems, “likes,” “votes,” and other indications of approval are essentially free to give. They do not require the user to give up anything of value, and therefore have questionable value as endorsements. As “likes” and other indicators of approval are frequently used to sort and/or rank data in social media platforms, this can result in top-ranked posts which may receive a lot of “likes” or other indicators of approval, but which have little tangible value or benefit to users of a social media platform.

Accordingly, alternative technologies for ranking messages and posts in a social media platform are needed.

### BRIEF DESCRIPTION OF THE DRAWINGS

FIG. 1 illustrates a flowchart for a method for ranking messages in a social network based on a virtual currency according to an exemplary embodiment.

FIG. 2 illustrates an interface of social media network used for sharing content related to health and food according to an exemplary embodiment.

FIGS. 3A-3B illustrate an example of ranking messages in a social network based on a virtual currency according to an exemplary embodiment.

FIGS. 4A-4B illustrate another example of ranking messages in a social network based on a virtual currency according to an exemplary embodiment.

FIGS. 5A-5D illustrate another example of ranking messages in a social network based on a virtual currency according to an exemplary embodiment.

FIGS. 6A-6B illustrate another example of ranking messages in a social network based on a virtual currency according to an exemplary embodiment.

FIGS. 7A-7B illustrate another example of ranking messages in a social network based on a virtual currency according to an exemplary embodiment.

FIGS. 8A-8B illustrate an example of transforming the metadata to include timestamps according to an exemplary embodiment.

FIGS. 9A-9B illustrates an interface with potential sorting options according to an exemplary embodiment.

FIG. 10 illustrates a flowchart for accumulating virtual currency according to an exemplary embodiment.

FIGS. 11A-11L illustrate various aspects of the interface of the social network according to an exemplary embodiment.

FIG. 12 illustrates a method for transferring virtual currency in a social network according to an exemplary embodiment.

FIG. 13 illustrates an exemplary computing environment that can be used to carry out the methods described herein according to an exemplary embodiment.

### DETAILED DESCRIPTION

While devices, adapters, methods, apparatuses, and computer-readable media are described herein by way of examples and embodiments, those skilled in the art recognize that devices, adapters, methods, apparatuses, and computer-readable media for ranking messages in a social network based on a virtual currency are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

The Applicant has discovered novel methods and systems for ranking messages in a social network based on a virtual currency. The virtual currency of the current system can be earned and given for a variety of community activities such as leading a discussion, contributing data, answering research questions, and/or adding products to a database of the social network. The virtual currency of the present system can express value in a way traditional social media “likes” and “loves” do not: users can give a greater quantity of virtual currency from their bank to information that is more valuable, accurate, insightful, or meaningful, but they only have as many units of virtual currency as are in their bank or social media account. Comments, posts, topics, threads, and items that receive a greater number of units of virtual currency from community members can be elevated within conversation threads. This reflects the value the community is giving to those comments and helps other community members discern validity. This can be especially beneficial when the social network revolves around food and health, as accurate and factual information is of the utmost importance in this area.

The virtual currency can be implemented as a crypto-currency or otherwise be built upon a distributed block chain ledger. For example, the virtual currency can utilize block chain (such as side chains off the main block chain) to implement a distributed ledger that tracks the quantity of virtual currency associated with each account, post, and/or content item.

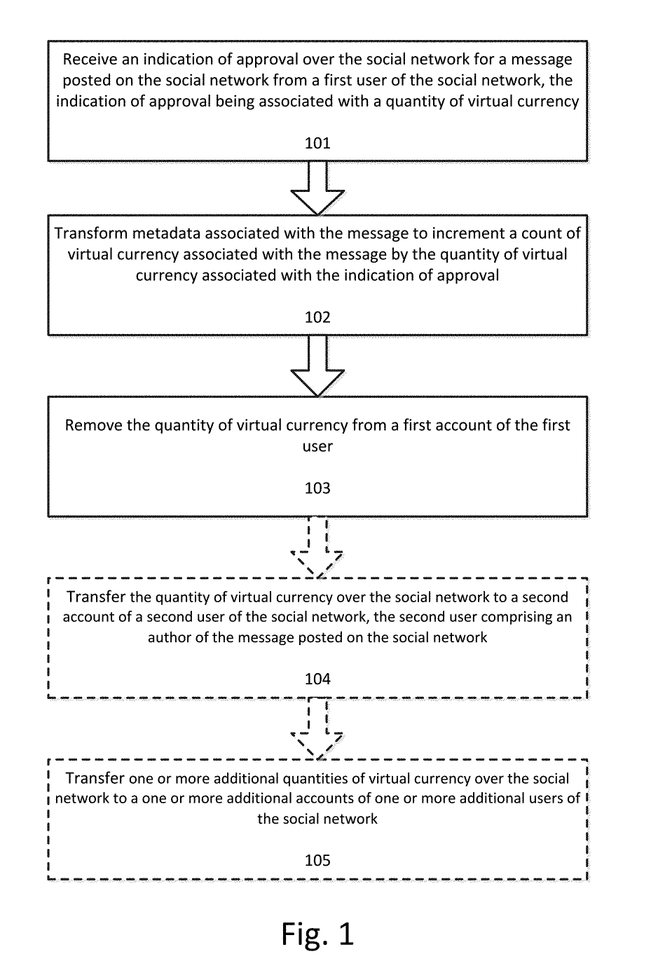

FIG. 1 illustrates a flowchart for a method for ranking messages in a social network based on a virtual currency according to an exemplary embodiment. At step 101 an indication of approval is received over the social network from a first user of the social network for a message posted on the social network. The indication of approval is associated with a quantity of virtual currency. The social network platform can check to verify that this quantity of currency is less than or equal to a balance of virtual currency in a first account of the first user on the social network prior to proceeding with the method.

The message can include, for example, a message posted in a message board, a forum thread, or other message exchange hub. As used herein, message can also refer to content created by the user, such as curated content. For example, a user can create curated content or content in a social network page, a web page linked to the social network (such as through an Application Programming Interface), or some other content medium. In this case, an indication of approval can be received over the social network for the curated content or content. For example, if the curated content is a web page linked to the social network, then the indication of approval can be received through a social network API embedded in the web page or otherwise linked to the web page.

For example, the indication of approval can be a user clicking on a message or an approval icon which is associated with a message (such as a “like” button). In this case, the quantity of virtual currency which is associated with the indication of approval can be a default or predetermined value, such as “1” or can be configured/customized by the user.

Alternatively, quantity of currency associated with the indication of approval can be set after the user provides the indication of approval. For example, a user can select an “approve” button associated with a message or a user can select a message which they approve of and a new input window can be opened which allows them to specify the quantity of currency they would like to associate with their indication of approval. This quantity can be selected from a number of preset options, such as “1, 5, 10 . . . etc.” or alternatively can be input by the user.

When the indication of approval is received, the system can determine whether the quantity of virtual currency associated with the indication of approval is greater than or equal to an amount of virtual currency in an account of the user that provided the indication of approval. If the amount of virtual currency in the user account is less than the quantity associated with the indication of approval, then the process can be halted and a message can be displayed to the user. For example, a message can be output indicating that the user has insufficient virtual currency funds to indicate approval in the manner requested. Alternatively, the user's indication of approval can simply be disregarded and no action can be taken when the user has insufficient virtual currency funds for the indication of approval. For example, if a user has zero units of a virtual currency and clicks an approval icon next to a message, the approval can simply not be registered with the system.

At step 102 metadata associated with the message is transformed to increment a count of virtual currency associated with the message by the quantity of virtual currency in the indication of approval. In the case of curated content, metadata associated with either the creator of the content (as described in step 104) or with the curated content itself can itself be transformed to increment a count of virtual currency associated with either the creator of the content or with the curated content. For example, if a user creates a curated content article titled “Five tech gadgets on everyone's Christmas list” and an indication of approval is received over the social network for the curated content article (such as through the social network API), then the metadata associated with the article can be transformed to increment a count of virtual currency associated with the article. Additionally, or alternatively, the metadata or data associated with the account of the content creator can be transformed to increment a count of virtual currency as well. For example, if an author publishes 10 articles and each of the ten articles receives 5 indications of approval, then a quantity of virtual currency associated with the account of the author on the social network would be incremented 50 times.

When the virtual currency is implemented as a crypto-currency or otherwise uses distributed ledger, the step of updating the metadata associated with the message, user account, and/or content can include updating the distributed ledger that tracks the quantities of virtual currency.

The social network can be configured to rank one or more messages posted on the social network based at least in part on a quantity of virtual currency associated with each message in the one or more messages. In the case of content or curated content, the social network can be configured to rank curated content articles based at least in part on a quantity of virtual currency associated with either the curated content articles and/or a quantity of virtual currency associated with an account of curated content creators. For example, the social network can rank all articles based upon the quantity of virtual currency associated with all authors of the articles. Alternatively, or additionally, the social network can rank all content articles based upon the quantity of virtual currency associated with each content article.

Additionally, as will be discussed further below, the metadata associated with the message can also be transformed to include a timestamp or other time-related indicator associated with the indication of approval. For example, if the user selects the indication of approval at 3:55 PM on Jan. 3, 2017, then a timestamp indicating this time can be stored as part of the metadata and stored in association with the quantity of virtual currency which is associated with the indication of approval. In this case, the social network can be configured to rank one or more messages posted on the social network based at least in part on a quantity of virtual currency associated with each message in the one or more messages and one or more timestamps associated with each message in the one or more messages.

At step 103 of FIG. 1, the quantity of virtual currency associated with the indication of approval is removed from the first account of the first user. For example, if the indication of approval was associated with 3 units of virtual currency, then 3 units of virtual currency can be removed from the first account of the first user with the social network.

When the virtual currency is implemented as a crypto-currency or otherwise uses distributed ledger, the step of removing the quantity of virtual currency from the first account of the first user can include updating the distributed ledger that tracks the quantities of virtual currency.

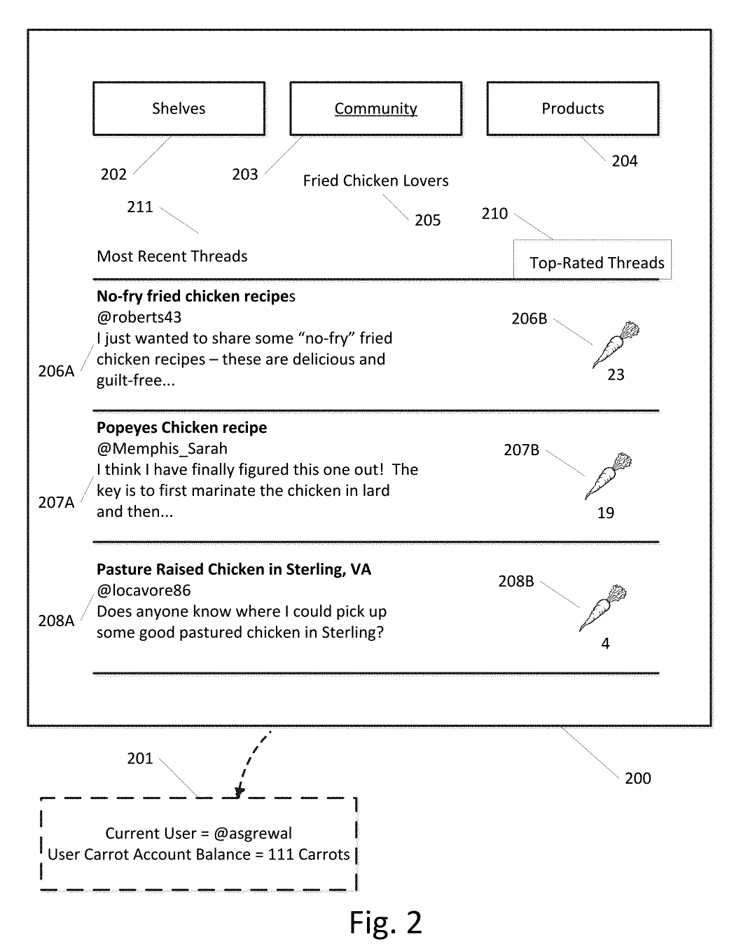

Steps 101-103 are explained further with regard to the examples shown in FIGS. 2, 3A-3B, 4A-4B, and 5A-5D. FIG. 2 illustrates an interface 200 of social media network used for sharing content related to health and food. Interface 200 includes tabs 202, 203, and 204.

“Shelves” tab 202 refers to one or more virtual shelves which each hold one or more virtual products that have been added to the social network by users. The virtual products correspond to real-life products and can be added to the social network, for example, by a user scanning a UPC code associated with a product. The virtual products can be organized into virtual shelves by users of the social network. For example, a user can create a virtual shelf called “Chinese Cooking Essentials” which can include virtual products necessary for Chinese cooking. Of course, the same virtual product can appear in multiple shelves.

“Products” tab 204 refers to a database of virtual products that have been added to the social network by users. As discussed above, the virtual products can be added by scanning the UPC codes of real life products, such as with a camera on a mobile device. Additionally, the virtual products can be provided by vendors, manufacturers, and/or downloaded from third party databases.

“Community” tab 203 refers to listing of “community groups” which are groups of users with common interests. As shown by the underlining in FIG. 2, the Community tab 203 is currently selected and is open to a community group called “Fried Chicken Lovers” 205. Users can join existing community groups, browse community group threads and messages, or create their own community groups.

Interface 200 illustrates three threads 206A, 207A, and 208A within the Fried Chicken Lovers 205 community group. These threads are ranked according to a sorting criterion 210, which is currently set to “Top-Rated Threads.” Also shown is another sorting criterion 211, which is set to “Most Recent Threads.” The user can optionally toggle between the different sorting criteria by selecting either 210 or 211. As shown in the figure, the user has currently selected “Top-Rated Threads” 210. Additionally, as discussed further below, the sorting criteria can be modified to rank threads and/or messages upon a variety of different criteria and using a variety of interface elements. Each of the threads includes a first message, which is illustrated under the thread name. For example, the “no-fried chicken recipes” thread 206A includes a message by user @roberts43.

The virtual currency which is associated with each thread is shown on the right hand side of interface 200 as carrots. Throughout this specification, the term “carrots” will be used interchangeably with the term “virtual currency.” For example, thread 206A has a carrot count (virtual currency count) of 23 carrots, as indicated by numeral 206B. Thread 207A has 19 carrots 207B. Thread 208A has 4 carrots 208B.

Additionally, box 201 of FIG. 2 illustrates information regarding the current user of the interface 200, including the account balance of the current user. In this example, the current user is @asgrewal and the carrot account balance of the user is 111 carrots.

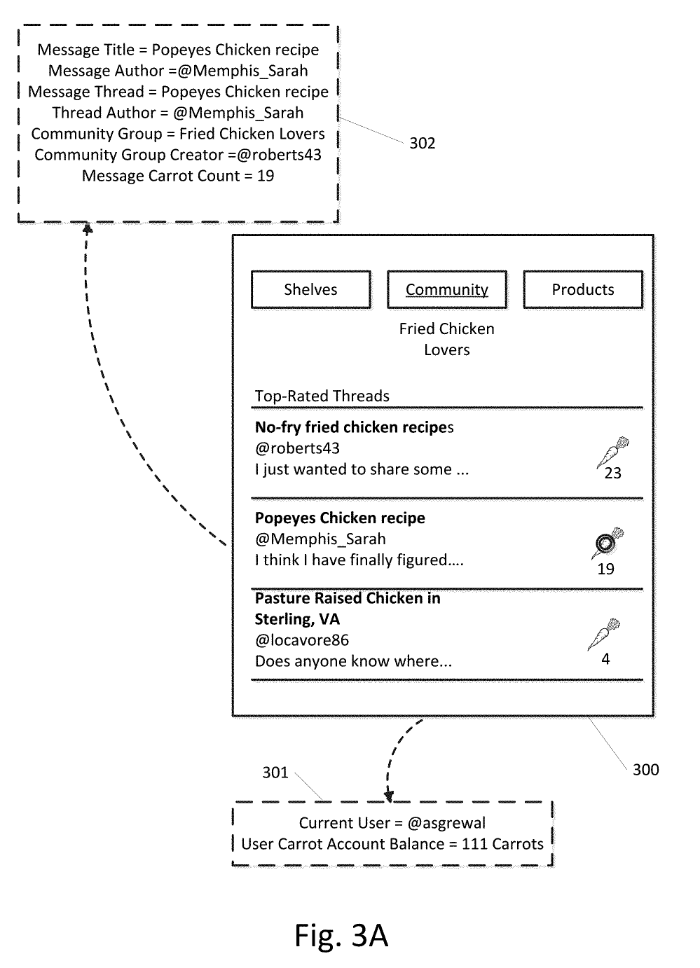

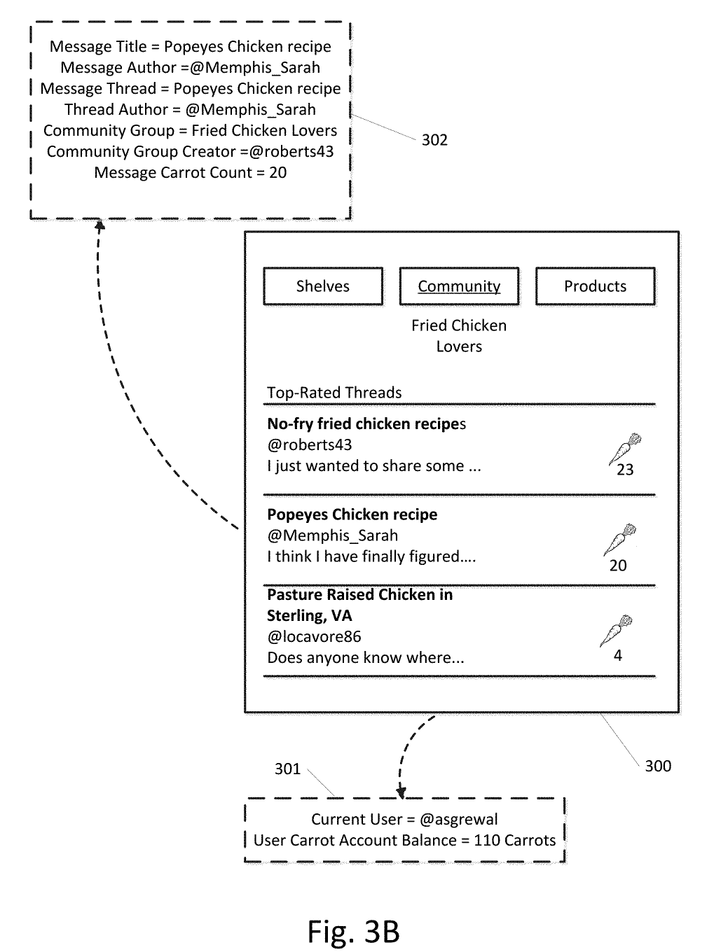

FIGS. 3A-3B illustrate an example of ranking messages in a social network based on a virtual currency according to an exemplary embodiment. Interface 300 in FIG. 3A illustrates the receiving of an indication of approval via a user selection of the carrot icon corresponding to the first message in the thread “Popeyes Chicken Recipe.” The selection is shown as two concentric circles. The selection can be received via a touch interface, a mouse pointer, or any other input interface. Additionally, the selection can be received via one or more gestures, such as a tap, swipe, double-tap, etc. In this case, the quantity associated with the indication of approval can be set to 1, or 1 carrot per tap/click. Additionally, as discussed earlier, the user can also express approval by clicking directly on the message or some other icon/area associated with the message.

Box 301 of FIG. 3A is similar to box 201 in FIG. 2 and illustrates the current user and their account balance. Additionally, box 302 of FIG. 3A illustrates metadata associated with the first message in the thread “Popeyes Chicken Recipe.” As shown in box 302, the message author and the thread author (since the message is the first in the thread) is @Memphis_Sarah. Additionally, the Community Creator is @roberts43, who is the author of a different thread in the community group.

FIG. 3B illustrates the results of receiving the indication of approval in FIG. 3A. As shown in interface 300 of FIG. 3B, the quantity of carrots associated with the message “Popeyes Chicken recipe” is increased from 19 to 20. Additionally, as shown in box 302 of FIG. 3B, the metadata corresponding to that message has been transformed to increment the count of carrots associated with the message. The quantity of carrots has also been deducted from the account of the user, as shown in box 301 of FIG. 3B.

As this change in carrots does not result in a change in the numerical ordering of the carrot counts of each of the threads within interface 300, the order of threads in FIG. 3B remains the same as FIG. 3A.

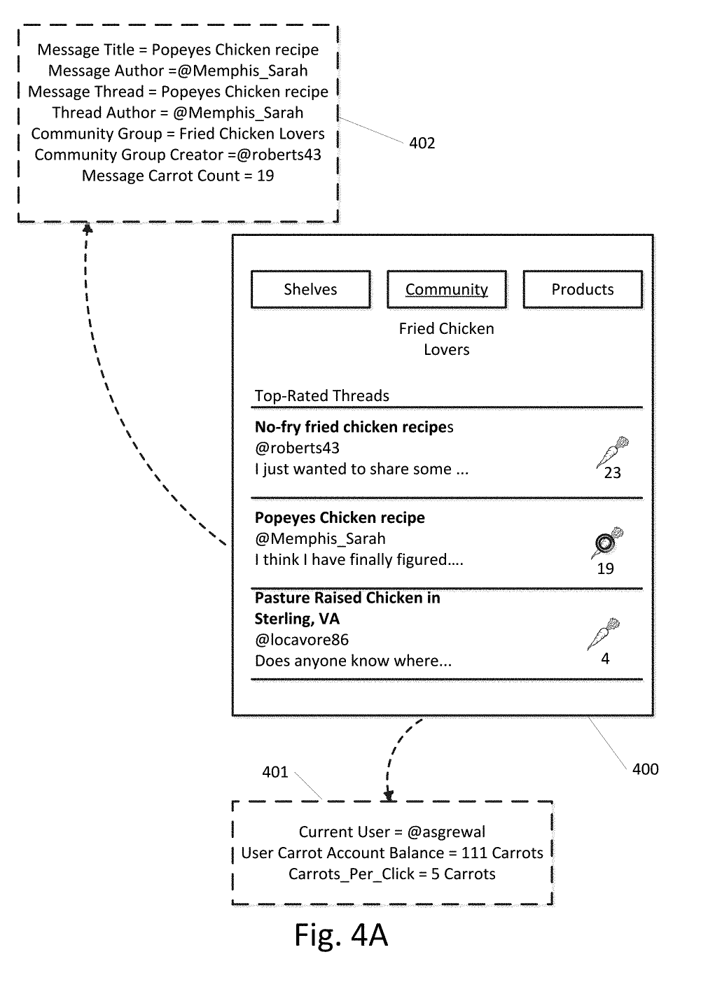

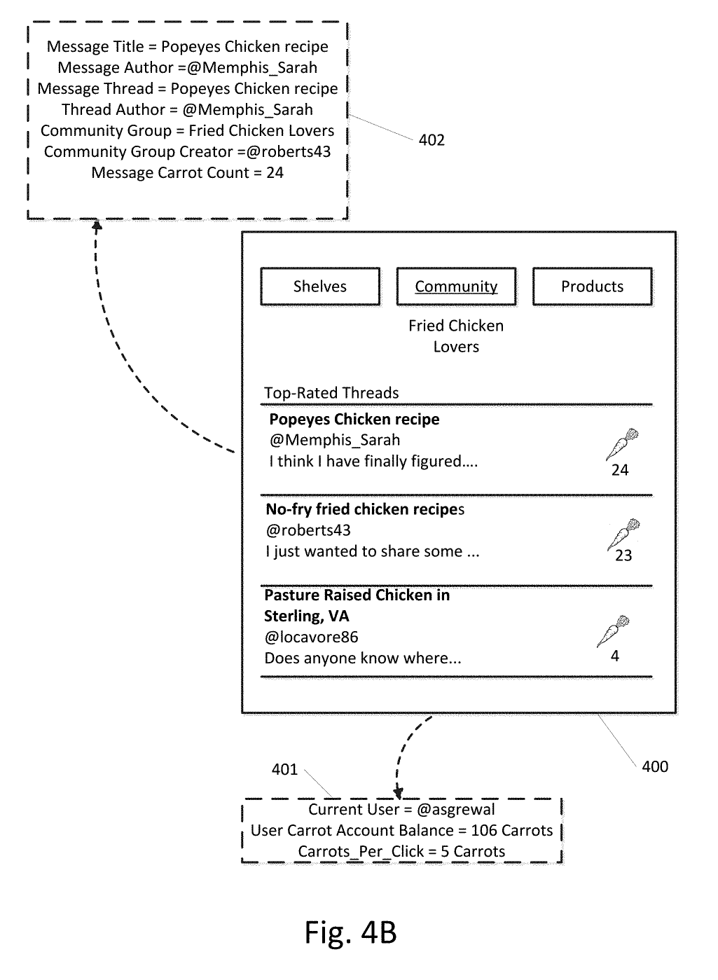

FIGS. 4A-4B illustrate another example of ranking messages in a social network based on a virtual currency according to an exemplary embodiment. Interface 400 in FIG. 4A illustrates the receiving of an indication of approval via a user selection of the carrot icon corresponding to the first message in the thread “Popeyes Chicken Recipe.” The selection is shown as two concentric circles. The selection can be received via a touch interface, a mouse pointer, or any other input interface. Additionally, the selection can be received via one or more gestures, such as a tap, swipe, double-tap, etc.

Box 401 of FIG. 4A illustrates the current user and their account balance. Additionally, box 401 illustrates a “Carrots-per-click” value. This value can be set by the user and can be used to determine the quantity of carrots associated with each indication of approval. In this case, the user has it set to 5 carrots, meaning each time the user expresses an indication of approval (such as a tap or a click), 5 carrots are associated with the indication of approval.

Box 402 of FIG. 4A illustrates metadata associated with the first message in the thread “Popeyes Chicken Recipe.” As shown in box 402, the message author and the thread author (since the message is the first in the thread) is @Memphis_Sarah. Additionally, the Community Creator is @roberts43, who is the author of a different thread in the community group.

FIG. 4B illustrates the results of receiving the indication of approval in FIG. 4A. As shown in interface 400 of FIG. 4B, the quantity of carrots associated with the message “Popeyes Chicken recipe” is increased from 19 to 24. Additionally, as shown in box 402 of FIG. 4B, the metadata corresponding to that message has been transformed to increment the count of carrots associated with the message. The quantity of carrots has also been deducted from the account of the user, as shown in box 401 of FIG. 4B.

In this case, the change in carrots does results in a change in the numerical ordering of the carrot counts of each of the threads within interface 400. Therefore, as shown in in interface 400 of FIG. 4B, the “Popeyes Chicken Recipe” is now ranked first.

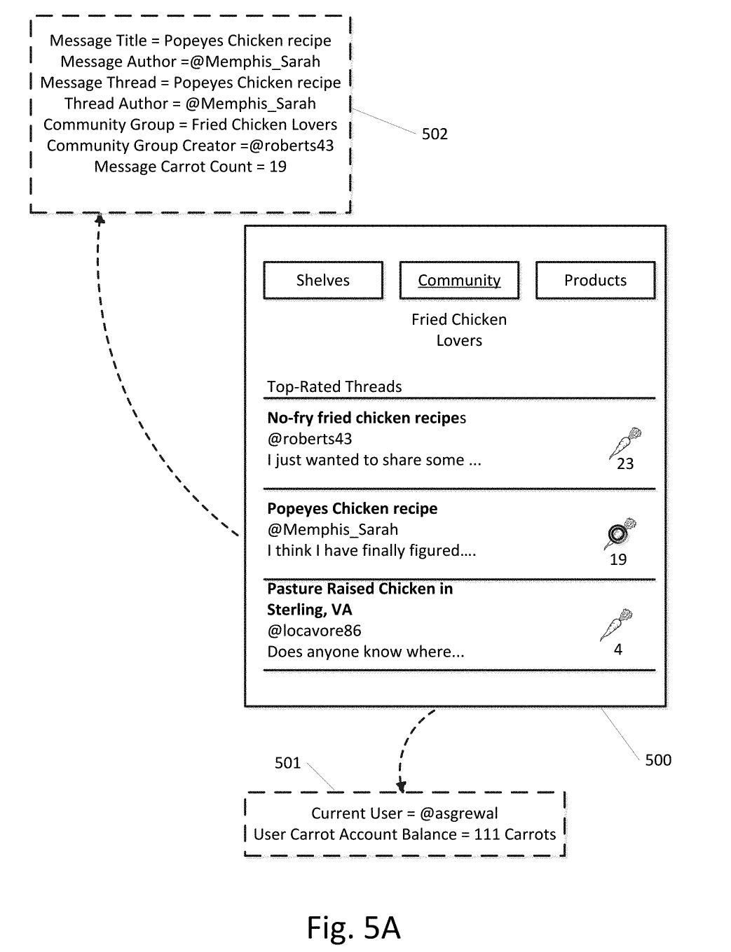

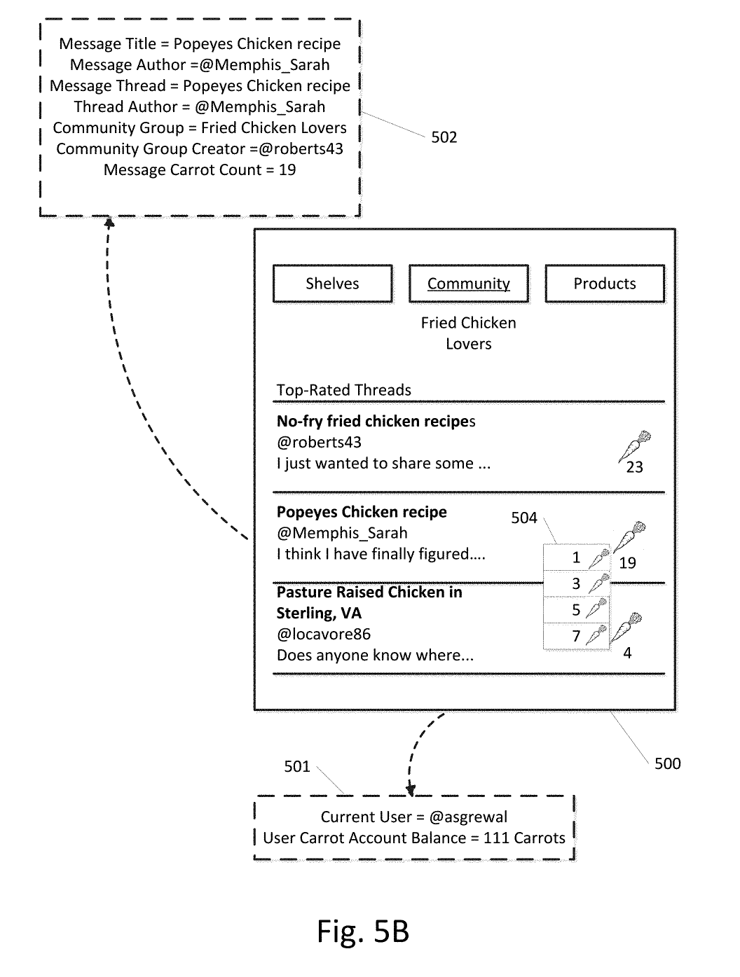

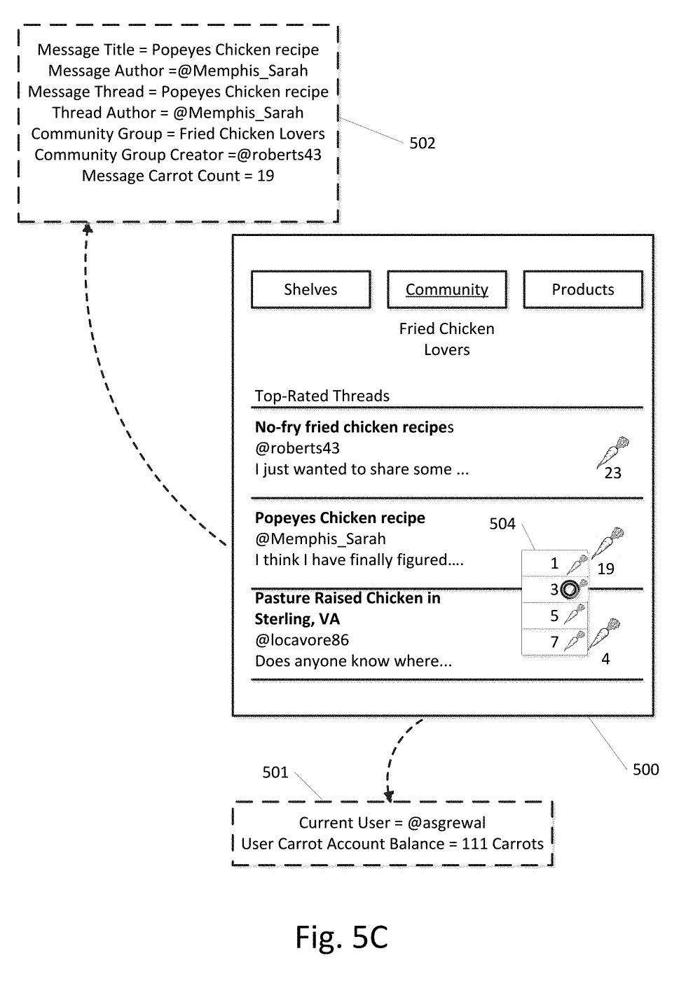

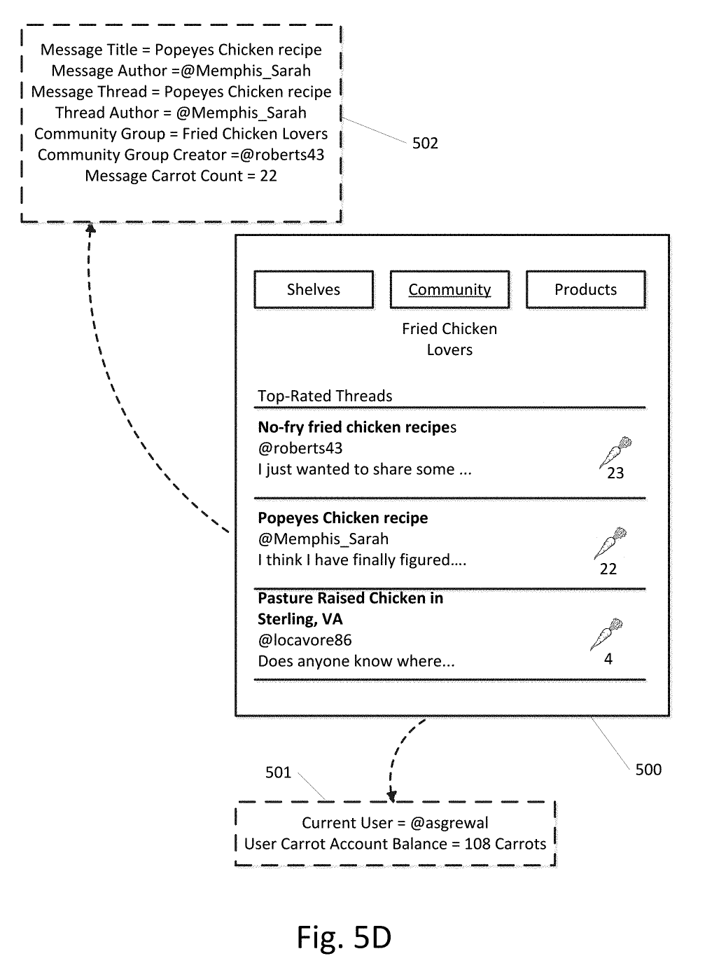

FIGS. 5A-5D illustrate another example of ranking messages in a social network based on a virtual currency according to an exemplary embodiment. Interface 500 in FIG. 5A illustrates a user selection of the carrot icon corresponding to the first message in the thread “Popeyes Chicken Recipe.” The selection is shown as two concentric circles. The selection can be received via a touch interface, a mouse pointer, or any other input interface. Additionally, the selection can be received via one or more gestures, such as a tap, swipe, double-tap, etc.

Box 501 of FIG. 5A illustrates the current user and their account balance. Additionally, box 502 of FIG. 5A illustrates metadata associated with the first message in the thread “Popeyes Chicken Recipe.” As shown in box 502, the message author and the thread author (since the message is the first in the thread) is @Memphis_Sarah. Additionally, the Community Creator is @roberts43, who is the author of a different thread in the community group.

FIG. 5B illustrates the results of receiving the selection in FIG. 5A. As shown in FIG. 5B, the selection results in the appearance of pop-up menu 504 which allows the user to select how many carrots they would like associated with the indication of approval. FIG. 5C illustrates the user selecting 3 carrots in the pop-up menu 504.

FIG. 5D illustrates the results of receiving the selection in FIG. 5C. As shown in interface 500 of FIG. 5D, the quantity of carrots associated with the message “Popeyes Chicken recipe” is increased from 19 to 22. Additionally, as shown in box 502 of FIG. 5D, the metadata corresponding to that message has been transformed to increment the count of carrots associated with the message. The quantity of carrots has also been deducted from the account of the user, as shown in box 501 of FIG. 5D.

As this change in carrots does not result in a change in the numerical ordering of the carrot counts of each of the threads within interface 500, the order of threads in FIG. 5D remains the same as FIG. 5A.

Returning to FIG. 1, at optional step 104, the quantity of virtual currency which was subtracted from the account of the first user can be transferred over the social network to a second account of a second user of the social network, the second user comprising an author of the message posted on the social network or an author of content, such as a curated content article, that is accessible on the social network or otherwise linked to the social network.

When the virtual currency is implemented as a crypto-currency or otherwise uses distributed ledger, the step of transferring the quantity of virtual currency can include updating the distributed ledger that tracks the quantities of virtual currency.

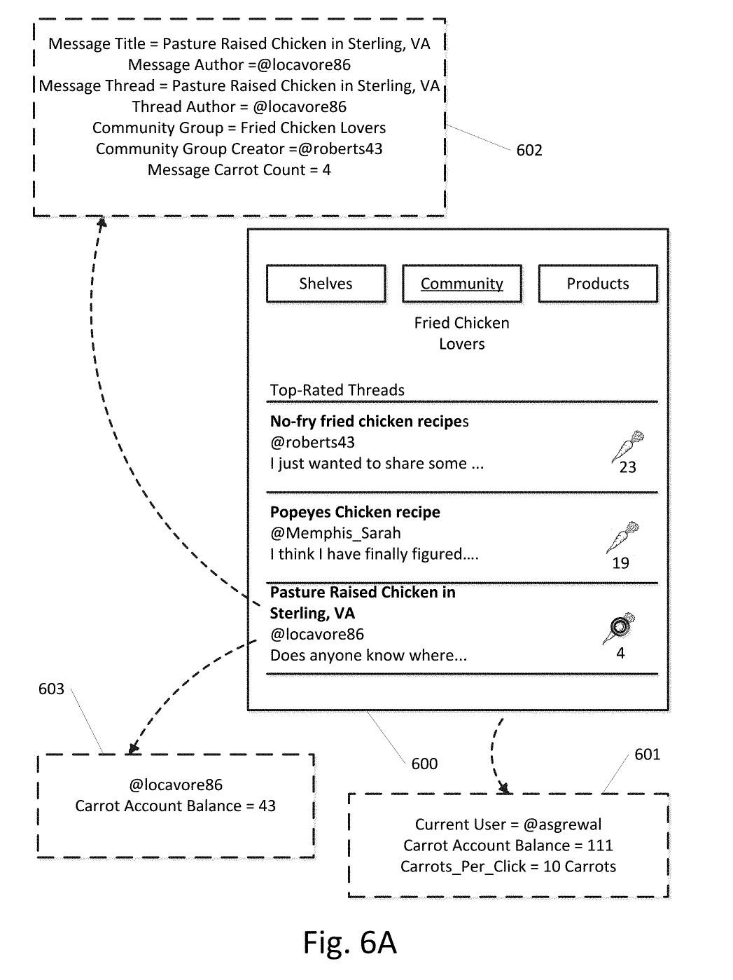

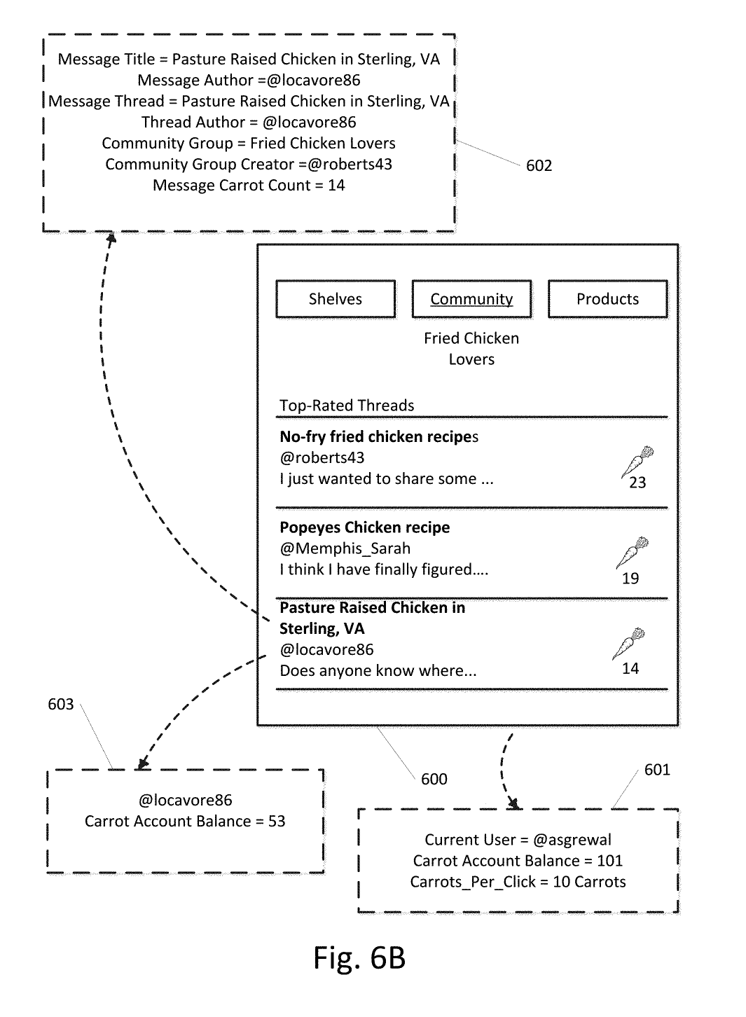

Step 104 is explained further with respect to FIGS. 6A-6B. FIGS. 6A-6B illustrate an example of ranking messages in a social network based on a virtual currency according to an exemplary embodiment. Interface 600 in FIG. 6A illustrates the receiving of an indication of approval via a user selection of the carrot icon corresponding to the first message in the thread “Pasture Raised Chicken in Sterling, Va.” The selection is shown as two concentric circles. The selection can be received via a touch interface, a mouse pointer, or any other input interface. Additionally, the selection can be received via one or more gestures, such as a tap, swipe, double-tap, etc. In this case, the quantity associated with the indication of approval is set to 10 carrots, as shown in box 601.

Box 602 of FIG. 6A illustrates metadata associated with the first message in the thread “Pasture Raised Chicken in Sterling, Va.” As shown in box 602, the message author and the thread author (since the message is the first in the thread) is @locavore86. Additionally, the Community Creator is @roberts43, who is the author of a different thread in the community group.

Box 603 illustrates account information corresponding to user @locavore86, indicating a balance of 43 carrots.

FIG. 6B illustrates the results of receiving the indication of approval in FIG. 6A. As shown in interface 600 of FIG. 6B, the quantity of carrots associated with the message “Pasture Raised Chicken in Sterling, Va.” is increased from 4 to 14. As shown in box 602 of FIG. 6B, the metadata corresponding to that message has been transformed to increment the count of carrots associated with the message. The quantity of carrots has also been deducted from the account of the current user, as shown in box 601 of FIG. 6B. Additionally, the quantity of carrots associated with the indication of approval has been deposited into the account of @locavore86, as shown in box 603 of FIG. 6B. Therefore, @locavore86 now has 63 carrots.

Returning to FIG. 1, at optional step 105, one or more additional quantities of virtual currency are transferred over the social network to one or more additional accounts of one or more additional users of the social network. This step can include depositing a second quantity of currency into a third account of a third user of the social network, wherein the third user comprises a creator of the topic on the social network and wherein the second quantity comprises a predetermined percentage of the first quantity. This step can also include depositing a third quantity of currency into a fourth account of a fourth user of the social network, wherein the fourth user comprises a creator of the community group on the social network and wherein the third quantity comprises a predetermined percentage of the first quantity.

When the virtual currency is implemented as a crypto-currency or otherwise uses distributed ledger, the step of transferring one or more additional quantities of virtual currency to one or more additional accounts can include updating the distributed ledger that tracks the quantities of virtual currency.

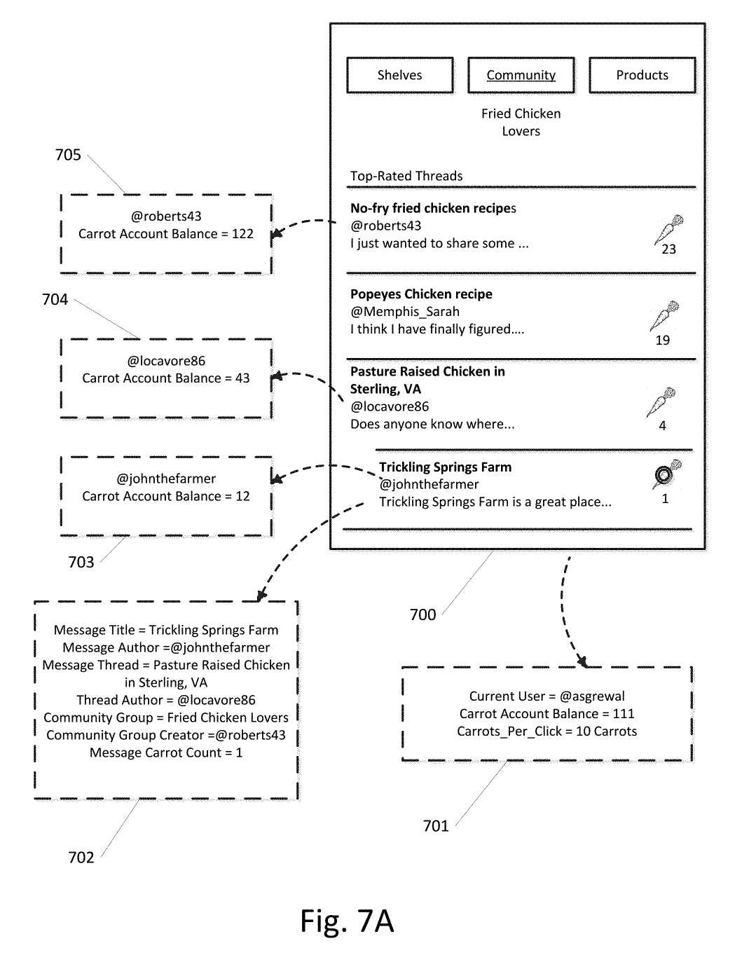

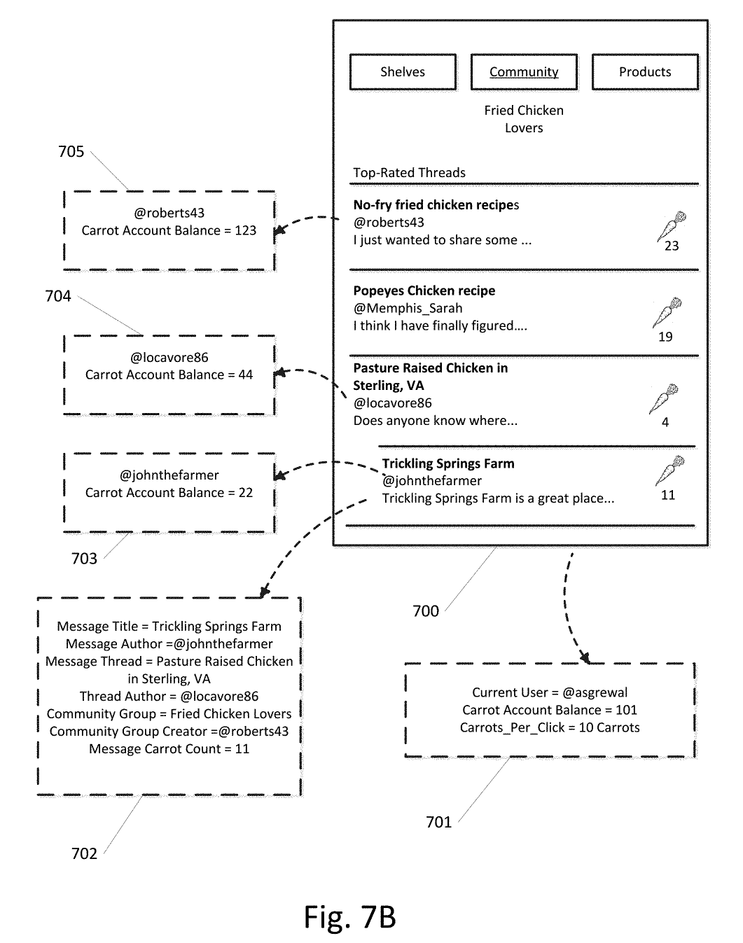

Step 105 is explained further with respect to FIGS. 7A-7B. FIGS. 7A-7B illustrate an example of ranking messages in a social network based on a virtual currency according to an exemplary embodiment. Interface 700 in FIG. 7A illustrates the receiving of an indication of approval via a user selection of the carrot icon corresponding to the message “Trickling Springs Farm” in the thread “Pasture Raised Chicken in Sterling, Va.” The selection is shown as two concentric circles. The selection can be received via a touch interface, a mouse pointer, or any other input interface. In this case, the quantity associated with the indication of approval is set to 10 carrots, as shown in box 701.

Box 702 of FIG. 7A illustrates metadata associated with the message “Trickling Springs Farm” in the thread “Pasture Raised Chicken in Sterling, Va.” As shown in box 702, the message author is @johnthefarmer and the thread author is @locavore86. Additionally, the Community Creator is @roberts43, who is the author of a different thread in the community group.

Box 703 illustrates account information corresponding to user @johnthefarmer, indicating a balance of 12 carrots.

Box 704 illustrates account information corresponding to user @locavore86, indicating a balance of 43 carrots.

Box 705 illustrates account information corresponding to user @roberts43, indicating a balance of 122 carrots.

FIG. 7B illustrates the results of receiving the indication of approval in FIG. 7A. As shown in interface 700 of FIG. 7B, the quantity of carrots associated with the message “Trickling Springs Farm” is increased from 1 to 11. As shown in box 702 of FIG. 7B, the metadata corresponding to that message has been transformed to increment the count of carrots associated with the message. The quantity of carrots has also been deducted from the account of the current user, as shown in box 701 of FIG. 7B and has been deposited into the account of @johnthefarmer, as shown in box 703 of FIG. 7B. Therefore, @johnthefarmer now has 12 carrots. Additionally, 10% of the carrots associated with the indication of approval have been deposited into the accounts of the topic/thread creator @locavore86 and the community group creator @roberts43. As the number of carrots associated with the indication of approval is 10, then 10% of those carrots is 1 carrot. As shown in boxes 704 and 705, 1 carrot has been added to the accounts of @locavore86 and @roberts43. Of course, the percentage of carrots that are deposited does not have to be 10% and can be any predetermined percentage. The predetermined percentage can be set by a site administrator, community group administrator, or other user. The predetermined percentage can also be calculated based on one or more parameters pertaining to the users involved, the message, topic, community, etc.

When the message comprises content, such as a curated content article, step 105 can include transferring virtual currency to additional accounts of additional users either associated with the content creator or with the content itself. For example, if the content is an article, then the accounts of an organization associated with the article author, a publisher of the article, an illustrator of the article, an editor of the article, or anyone else associated with the article or the article's author can receive virtual currency.

As discussed earlier, when an indication of approval is received from a user, the metadata can be transformed to include a timestamp associated with the indication of approval and the social network can be configured to rank the one or more messages posted on the social network based at least in part on a quantity of virtual currency associated with each message in the one or more messages and one or more timestamps associated with each message in the one or more messages.

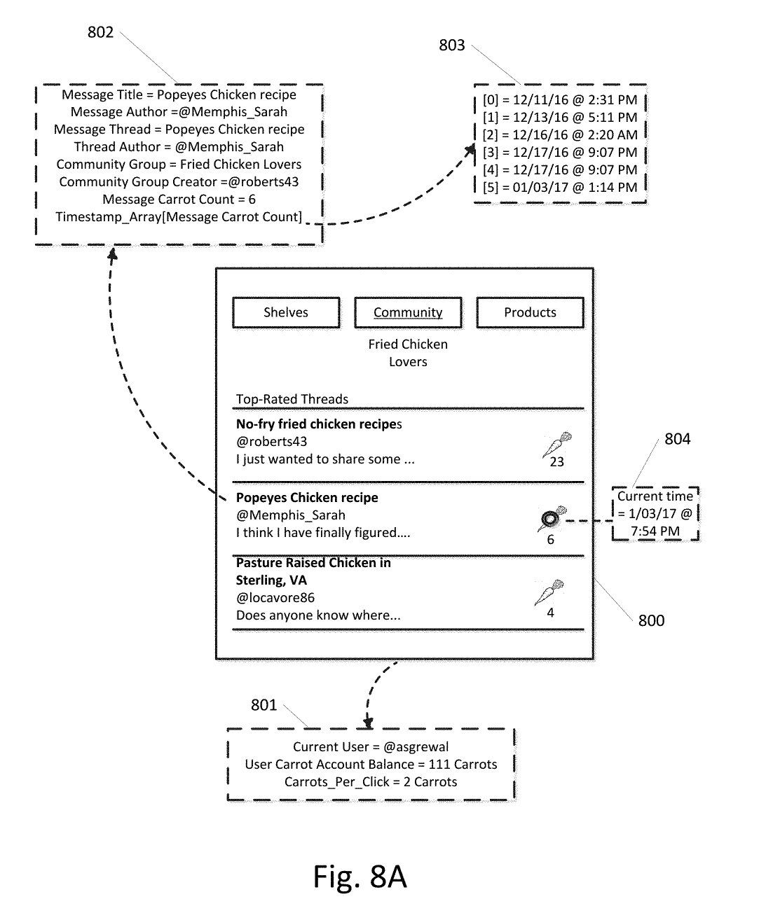

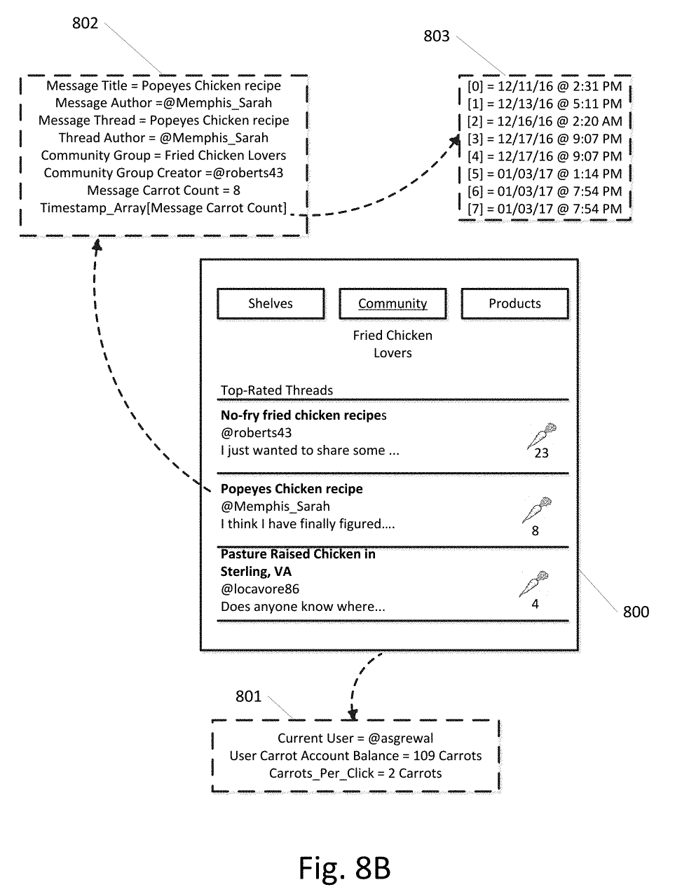

An example of transforming the metadata to include timestamps is shown in FIGS. 8A-8B. FIG. 8A illustrates an interface 800 in which a user has selected the carrot icon corresponding to the first message in thread “Popeyes Chicken Recipe.” As shown in FIG. 8A, the current date and time 804 when the user selected the carrot icon (indicating approval) is Jan. 3, 2017 at 7:54 PM. Box 801 again indicates the account information corresponding to the current user, including a “Carrots_per_click” of 2 carrots.

Box 802 indicates metadata associated with the first message in thread “Popeyes Chicken Recipe.” This is similar to the previously described metadata but includes an additional field “Timestamp_Array.” This variable is an array of timestamps corresponding to the currency which is associated with the message. The contents of the timestamp array are shown in box 803. The timestamp array can be used to determine when a particular unit of currency was associated with the message (when a user indicated approval of the message). For example, the first carrot was associated with the message on Dec. 11, 2016 at 2:31 PM. Additionally, the fourth and fifth carrots were associated with the message on Dec. 17, 2016 at 9:07 PM.

FIG. 8B illustrates the results of the selection in FIG. 8A. Similar to the other figures, the count of carrots associated with the message in the interface 800 and in the associated metadata 802 have increased by an amount corresponding to the decrease in the carrots in the account of the user, as shown in box 801. Additionally, the timestamp array 803 has been updated to add two new timestamps corresponding to the two carrots added to the metadata associated with the message. As shown in FIG. 8B, the two timestamps have the same value of Jan. 3, 2017 at 7:54 PM, which was the current time 804 in FIG. 8A.

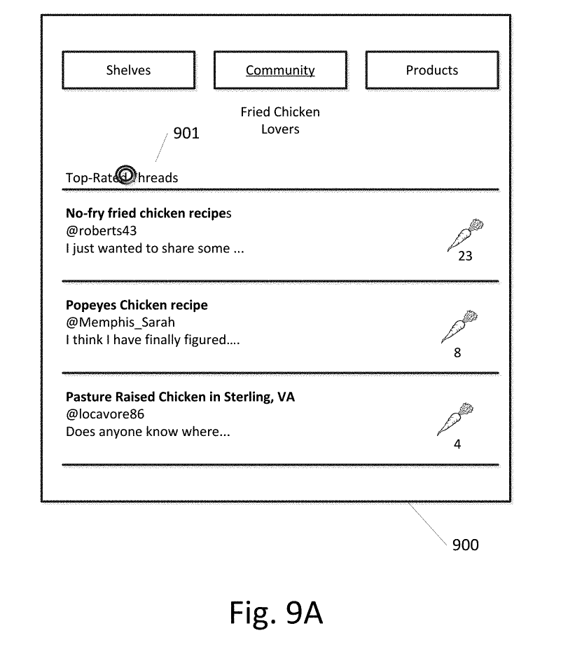

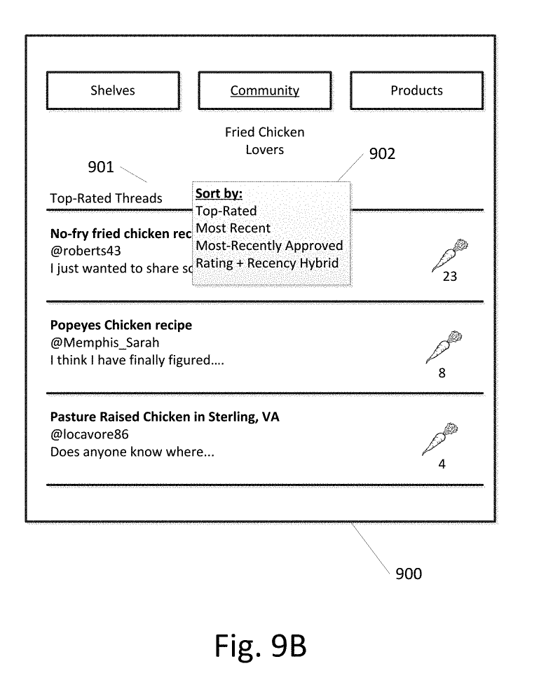

The timestamps can be used by the social network when sorting messages along criteria other than total quantity of carrots. For example, FIG. 9A illustrates an interface 900 in which the user has selected the sorting criteria 901. FIG. 9B illustrates a pop-up box 902 with potential sorting options, including “Top-Rated,” “Most Recent,” “Most-Recently Approved,” and “Rating+Recency Hybrid.” Top-Rated is just the message/thread with the highest number of associated virtual currency. Most Recent is the message/thread with the most recent entry. Most-Recently Approved can be the message/thread that most recently received an indication of approval with associated virtual currency. Additionally, Rating+Recency Hybrid can be some combination of the rating (based on virtual currency associated with the message) and the recency of approvals (based on timestamps associated with the message). For example, each of the carrots or units of currency can be weighted using a scale which weighs more recent units of currency more heavily than older units of currency.

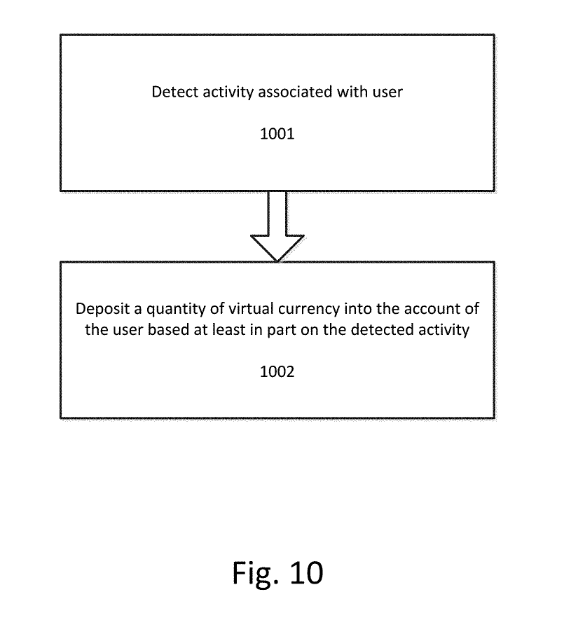

Users of the social network can accumulate virtual currency in a number of ways. FIG. 10 illustrates a flowchart for accumulating virtual currency according to an exemplary embodiment. At step 1001 activity associated with a first user is detected. The activity can include one or more of: initial registration of the first user with the social network; registration of a new user with the social network, the new user being referred by the first user; a daily login of the first user to the social network; creation of a new community group by the first user on the social network; creation of a new topic by the first user on the social network; an addition of a predetermined number of users of the social network to a community group created by the first user; responses from a predetermined number of users of the social network in a topic created by the first user; an addition to a first profile associated with the first user; or an addition of a credential to the first profile associated with the first user.

Additionally, when the social network includes a database of products, the activity can include one or more of: an addition by the first user of a predetermined number of products to the database of products; an addition by the first user of a predetermined number of photos of one or more products to the database of products; a correction by the first user to product data of a product in the database of products; or completion by the first user of one or more questions issued by a vendor of one or more products in the database of products.

At step 1002 a quantity of virtual currency is deposited into the account of the user based at least in part on the detected activity. The quantity deposited can vary based on which particular activity is detected. For example, the following distributions can be utilized:

| Carrot Criteria | Carrots |
|---|---|
| New Member Sign Up | 100 Carrots |
| Referred a Friend | 30 Carrots (bonus 30 every 10 friend |
| | referrals) |
| Daily Log-in | 10 Carrots (bonus 10 for 7 continuous |
| | days) |
| Scanned an Item | 5 Carrots (bonus 5 for every 10 scanned |
| | items) |
| Scanned a New item and | 10 Carrots (bonus 10 for every 10 |
| Photographed | photos) |
| Added or Corrected Item Data | 1 Carrot per line of data |
| Comments | Community-Given |
| Starts a New Community | 50 Carrots (bonuses based on growth |
| Group | and value of the group, as determined |
| | by group carrot activity) |
| Starts a New Topic within | 10 Carrots |
| Community | |
| 5 People Join Your Community | 10 Carrots |
| 5 People Respond to your Topic | 5 Carrots |
| For Each Profile Addition (Full | 5 Carrots |
| name, photo, location, | |
| demographics) | |
| Added a Credential | 75 Carrots |

Of course, the above carrot reward criteria are provided as an example only, and many other variations are possible. For example, carrots can be awarded for additional activities identified by users and/or site administrators. Additionally, the quantity of carrots awarded for each activity can vary.

The present system can include countermeasures to prevent users from gaming or taking advantage of the social network to gain carrots on their posts without expending any net carrots. For example, if members of a group were to exchange carrots back and forth by approving each other posts, then they could raise the carrot count of their posts without spending any carrots. They could also raise the carrot counts of the topic creator and the community group creator indefinitely. One countermeasure can be to use unique identifiers for each of the carrots that are generated so that the same carrot cannot be associated with a message more than once. This same countermeasure can be used to calculate the percentage of carrots awarded to a topic/group creator so that only previously uncounted carrots (carrots which do not have unique IDs matching existing carrots) are used to determine the percentage deposited in the accounts of topic/group creators.

A simpler countermeasure can be to establish a minimum number of group members to discourage gaming behaviors. For example, before awarding any carrots, a community group or topic may be required to reach a minimum threshold in members or replies.

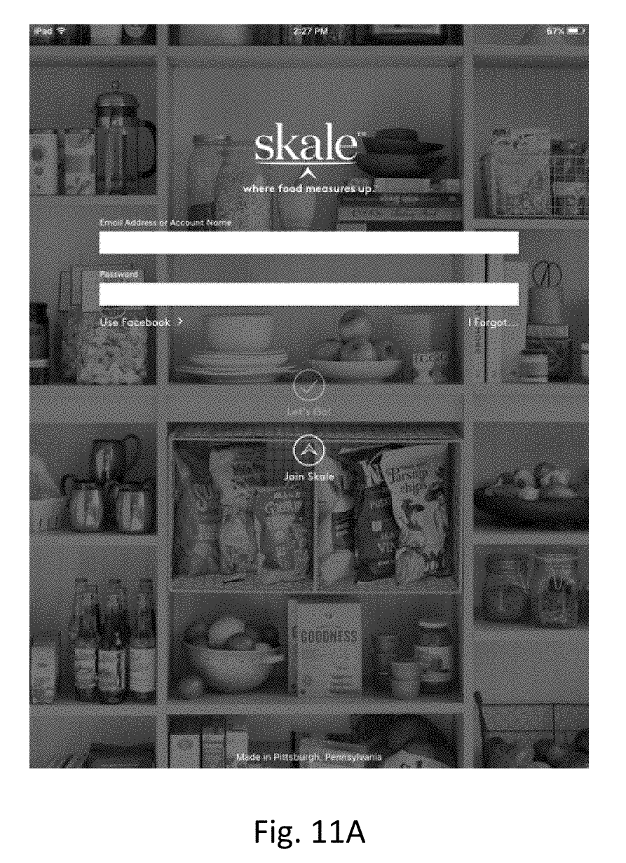

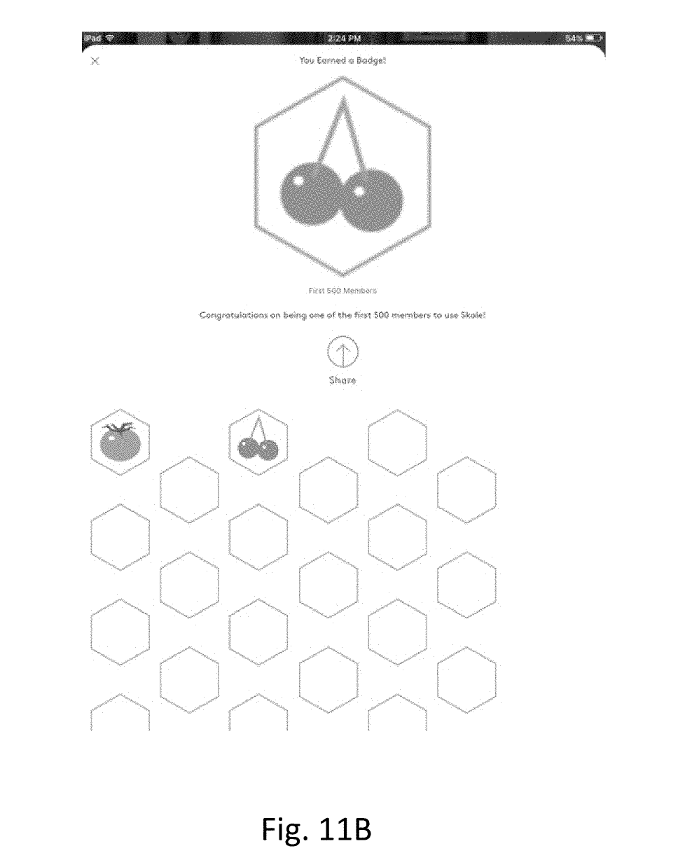

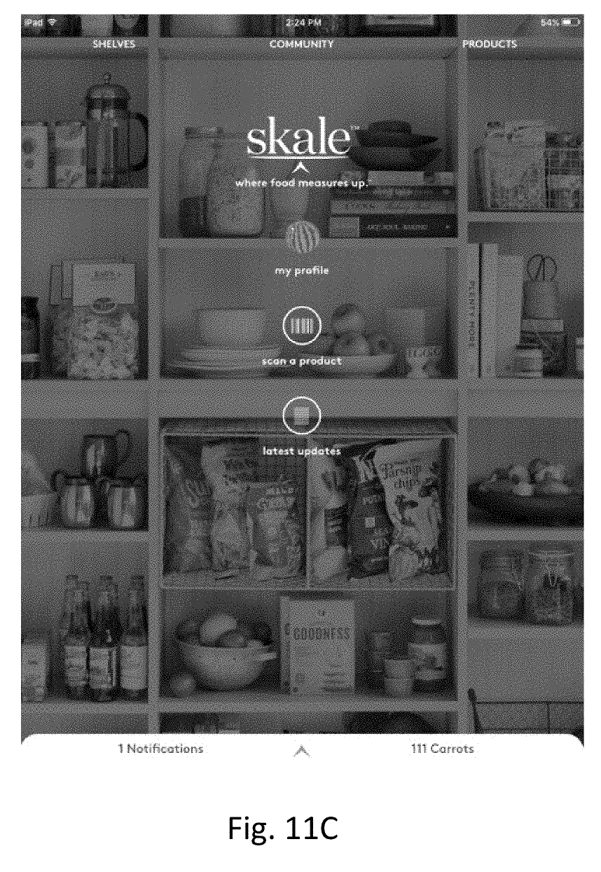

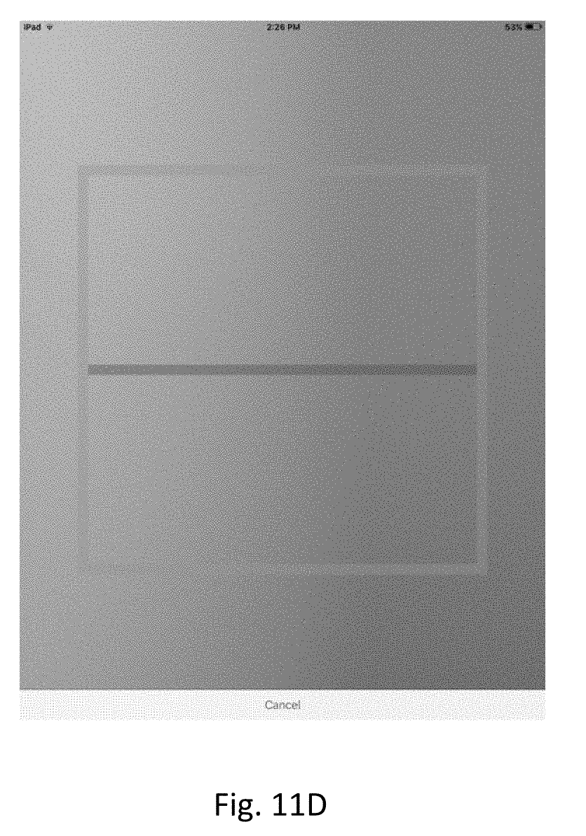

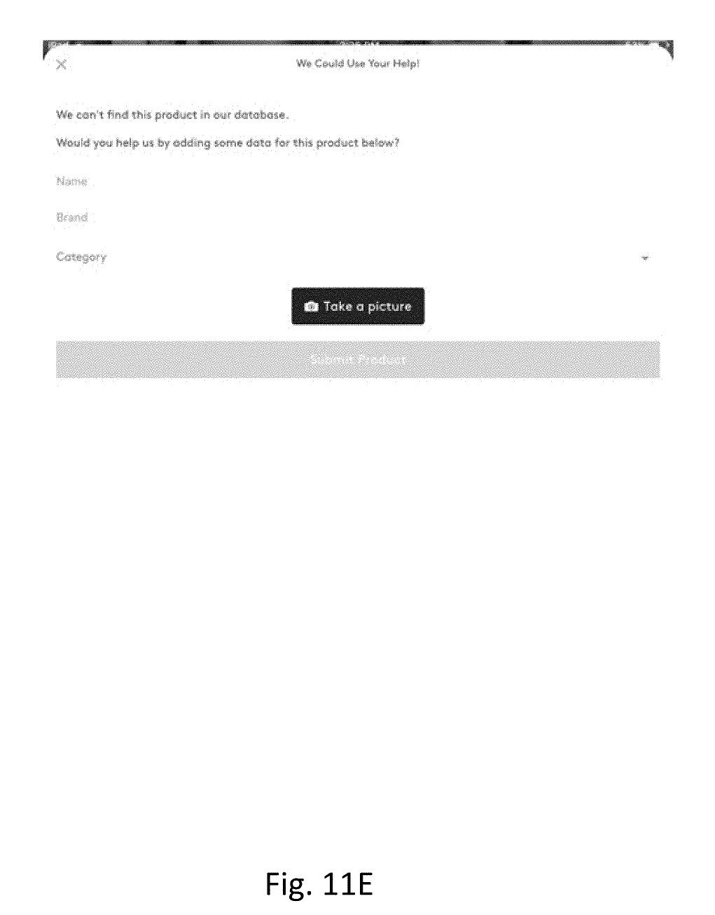

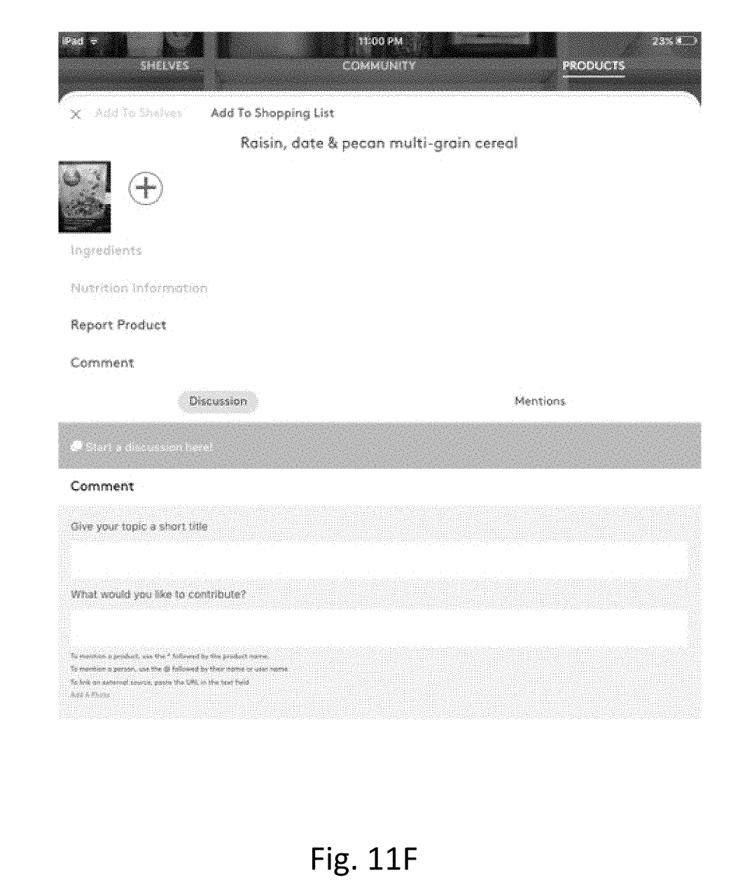

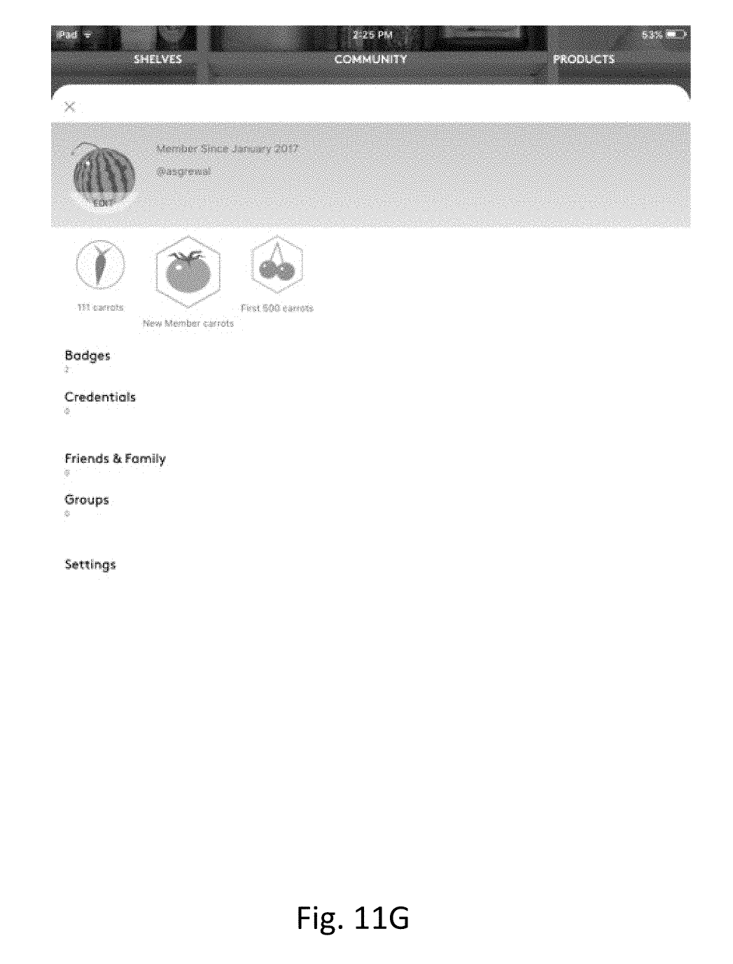

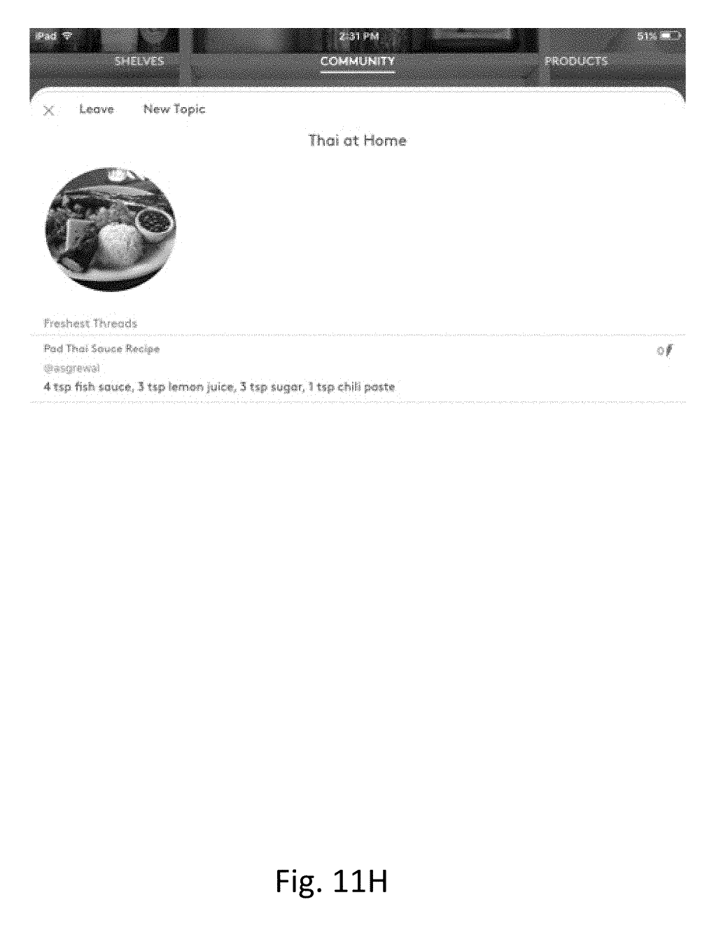

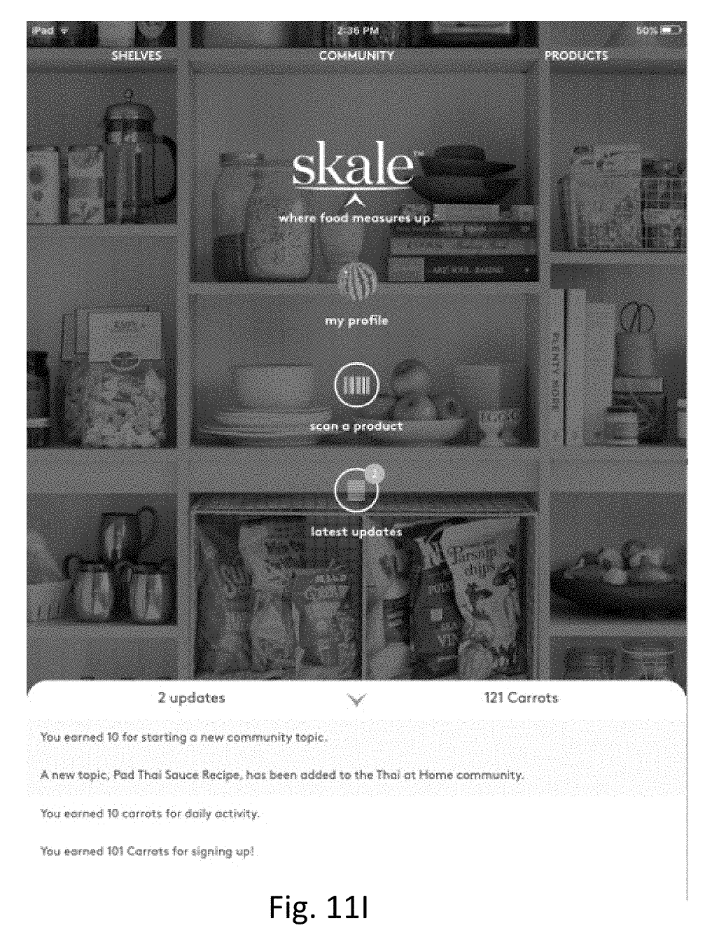

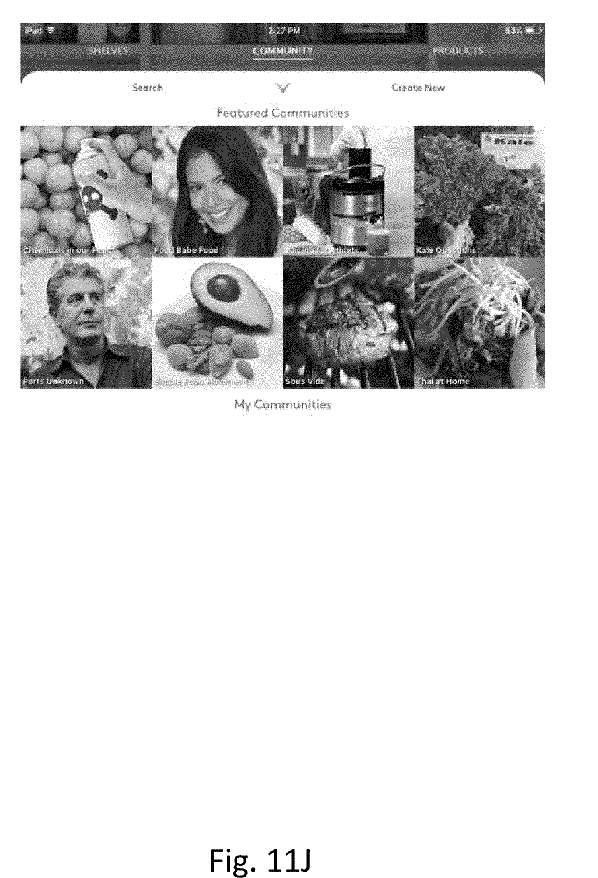

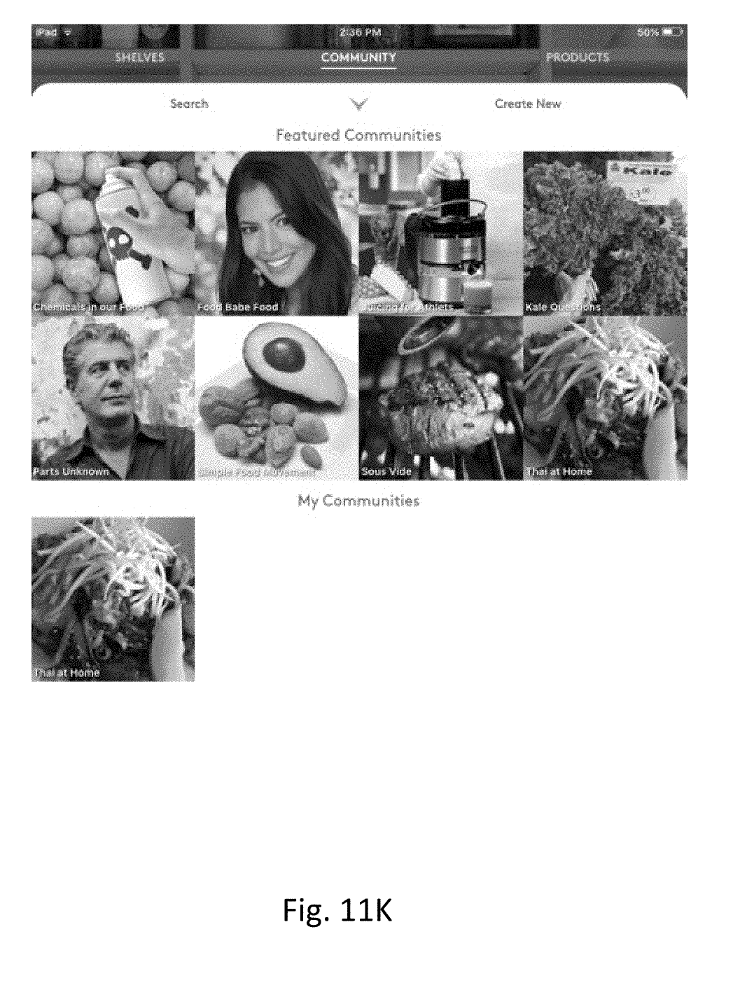

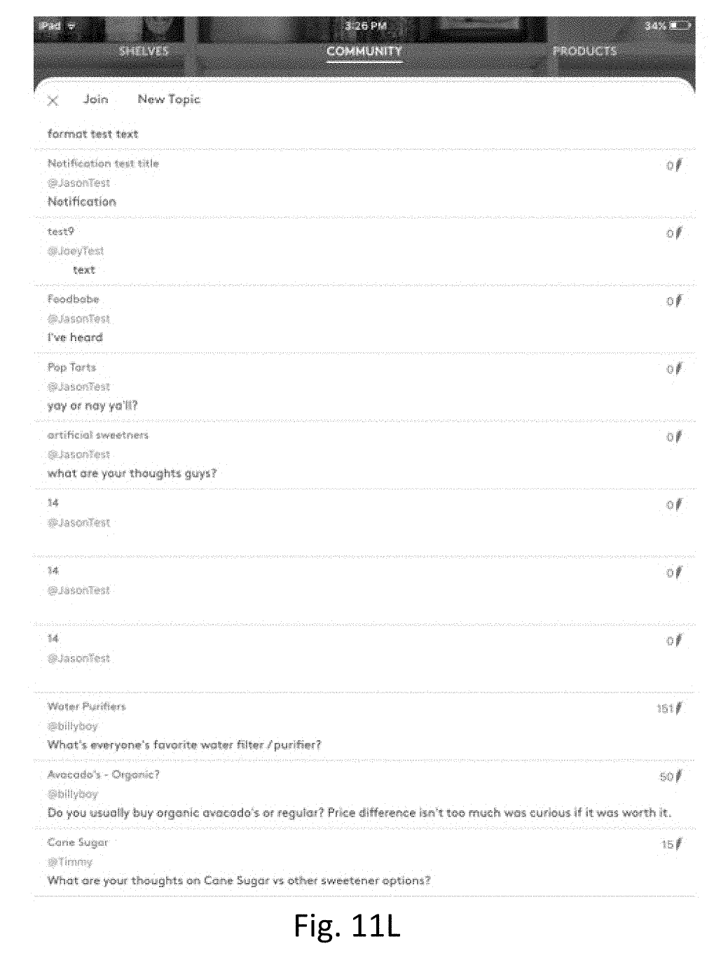

Additional features of the present system will be explained with reference to FIGS. 11A-11L, which illustrate various aspects of the interface of the social network according to an exemplary embodiment.

FIG. 11A illustrates a login screen of the social network. FIG. 11B illustrates a screen showing a user earning a “badge” for some activity or behavior. Various badges can be earned, as illustrated in the table below.

| Badge | Visual | Criteria | Associated Message |
|---|---|---|---|
| New Member | Kale (green) | Just for Joining | “Thanks for joining |
| | | | the network! Here's |
| | | | some kale! Earn |
| | | | badges and carrots as |
| | | | you participate and |
| | | | grow our |
| | | | community. We |
| | | | can't do it without |
| | | | you!” |
| A Regular | Cherries (pink) | Log In 7 Days in a | “You've earned a |
| | | Row | new badge! Thanks |
| | | | for coming to the |
| | | | network for 7 days |
| | | | in a row!” |
| A Regular | Cherries (redder) | Log In 30 Days in a | “You've earned a |
| | | Row | new badge! Thanks |
| | | | for coming to the |
| | | | network all this |
| | | | month! Our |
| | | | community grows |
| | | | and thrives because |
| | | | of members like |
| | | | you.” |
| A Regular | Cherries (redder) | Log In 90 Days in a | “You've earned a |
| | | Row | new badge! Thanks |
| | | | for coming to the |
| | | | network for three |
| | | | months straight! Our |
| | | | community grows |
| | | | and thrives because |
| | | | of exceptional |
| | | | members like you.” |
| A Regular | Cherries (red) | Log In for 200 of | “You must like it |
| | | 365 Days? | here. We like you, |
| | | | too, and are thankful |
| | | | for your regular |
| | | | participation. Here's |
| | | | a new badge!” |
| First 500 | Plum (light purple) | First 500 Members | “You earn a badge |
| Members | | | just for being one of |
| | | | our founding |
| | | | participants. Our |
| | | | community will |
| | | | continue to grow and |
| | | | we thank you for |
| | | | seeding it.” |
| First 10 | Plum (dark purple) | First 10 Members | “You earn a badge |
| Members | | | for being one of our |
| | | | first ten members! |
| | | | This one's quite |
| | | | special.” |
| Scanned 10 | Tomato (greenish) | Scanned 10 Items | “You've earned a |
| Items | | | badge for scanning |
| | | | 10 items!” |
| Scanned 50 | Tomato (ripening) | Scanned 50 Items | “You've earned a |
| Items | | | badge for scanning |
| | | | 50 items!” |
| Scanned 100 | Tomato (redish) | Scanned 100 Items | “You've earned a |
| Items | | | badge for scanning |
| | | | 100 items! Way to |
| | | | go!” |
| Scanned 500 | Tomato (red) | Scanned 500 Items | “You've earned a |
| Items | | | badge for scanning |
| | | | an incredible 500 |
| | | | items!” |
| Popular | Butternut Squash | Admin a Public | “You've earned a |
| Community | (light orange) | Community with 10+ | new badge for |
| Admin | | Members | creating such a |
| | | | popular community |
| | | | group!” |
| Really Popular | Butternut Squash | 50+ Members | “You've earned a |
| Community Admin | (orange) | | badge for creating a |
| | | | super popular |
| | | | community group! |
| | | | Thank you and keep |
| | | | it up!” |
| Really Active | Blueberries (blue) | Made 15+ Posts that | “You've earned a |
| Poster | | Garner Lots of | badge for creating |
| | | Responses (50% of | such a popular |
| | | posts get a response?) | community group! |
| | | | Thanks for all the |
| | | | energy you're putting |
| | | | into the network!” |
| Food | Clementine (light | Posted 10+ photos | “You've earned a |
| Photographer | orange) | | badge for posting 10 |
| | | | photos! Thanks!” |
| Gold Food | Clementine (orange) | Posted 50+ photos | “You shutterbug, |
| Photographer | | (calculated also based | you. You've earned a |
| | | on whether the images | badge for posting 50 |
| | | are selected as | photos!” |
| | | primaries?) | |
| Organizer | Brown Potato | Got 10 Friends to Join | “You've earned a |
| | | | badge for bringing |
| | | | ten friends to the |
| | | | network! We |
| | | | couldn't grow |
| | | | without your help!” |
| Pillar | Purple Potato | Got 25 Friends to Join | “You've earned a |
| | | | badge for bringing |
| | | | 25 friends to the |
| | | | network! We |
| | | | couldn't grow |
| | | | without your help!” |
| Exemplar | Golden Potato | Got 50 Friends to Join | “Wow! You've |
| | | | earned a badge for |
| | | | bringing an |
| | | | incredible 50 friends |
| | | | to the network! |
| | | | Thanks a million!” |
| Good Karma | Kiwi | Has credentials, may | “You've earned a |
| Badge | | not be very vocal, may | new badge! Thanks |
| | | not post much, but | for being so |
| | | gives lots of Thanks to | generous with your |
| | | others | carrots and assigning |
| | | | value to information |
| | | | that matters.” |
| Globe Trotter | Durian | Has scanned products | “You've earned a |
| | | from 2 continents or | new badge for |
| | | more | scanning products on |
| | | | more than one |
| | | | continent! *We're |
| | | | sorry, badge can not |
| | | | be exchanged for |
| | | | business class |
| | | | upgrade.” |
| Avocado Badge | Avocado | Has used the word | “You get a badge |
| | | avocado in a post at | just for saying |
| | | least once (do we have | ‘avocado.’” |
| | | sponsored badges by | |
| | | companies/industries?) | |
| Specific Interest | Eggplant | Frequent posts on a | “You've earned a |
| Badge: vegetarian or | | given subject: member | badge for being so |
| veganism | | of a special interest | active in the |
| | | group; participated x | community!” |
| | | number of times | |
| Specific Interest | Snap Peas | Frequent posts on a | “You've earned a |
| Badge: baby/children | | given subject: member | badge for being so |
| foods | | of a special interest | active in the |
| | | group; participated x | community!” |
| | | number of times | |
| Specific Interest | Grapes | Frequent posts on a | “You've earned a |
| Badge: wines | | given subject: member | badge for being so |
| | | of a special interest | active in the |
| | | group; participated x | community!” |
| | | number of times | |
| Specific Interest | Barley | Frequent posts on a | “You've earned a |
| Badge: beers | | given subject: member | badge for being so |
| | | of a special interest | active in the |
| | | group; participated x | community!” |
| | | number of times | |
| Specific Interest | Wheat | Frequent posts on a | “You've earned a |
| Badge: bread | | given subject: member | badge for being so |
| | | of a special interest | active in the |
| | | group; participated x | community!” |
| | | number of times | |
| Specific Interest | Sugar Cane | Frequent posts on a | “You've earned a |
| Badge: sweets | | given subject: member | badge for being so |
| | | of a special interest | active in the |
| | | group; participated x | community!” |
| | | number of times | |
| Specific Interest | Cocoa Bean | Frequent posts on a | “You've earned a |
| Badge: coffee | | given subject: member | badge for being so |
| | | of a special interest | active in the |
| | | group; participated x | community!” |
| | | number of times | |
| Specific Interest | Rhubarb | Frequent posts on a | “You've earned a |
| Badge: baking | | given subject: member | badge for being so |
| | | of a special interest | active in the |
| | | group; participated x | community!” |
| | | number of times | |
| Specific Interest | Brussels Sprout | Frequent posts on a | “You've earned a |
| Badge: athletics | | given subject: member | badge for being so |
| | | of a special interest | active in the |
| | | group; participated x | community!” |
| | | number of times | |
| Thanks | Apple | Given out to | “Thanks for adding |
| | | encourage something: | additional data! |
| | | fill out profile, answer | Here's a special |
| | | a question, add a | badge and x carrots “ |
| | | profile pic, clarify | |
| | | data. Could be mass- | |
| | | deployed to prompt | |
| | | data input. | |
| Extra Thanks | Fig | For doing something | “For helping to |
| (rare badge) | | really nice in the | report bad behavior |
| | | community, like | in the community, |
| | | policing/reporting a | we would like to |
| | | troll. Or we just | thank you with this |
| | | observe someone | fig badge.” |
| | | doing an upstanding | |
| | | thing. | |

FIG. 11C illustrates a home screen for a user, which has an option to scan a product to the network. FIG. 11D illustrates the interface when scanning a product. The bar code or QR code can be centered in the box shown on the interface. FIG. 11E illustrates a screen when the product isn't found in the database. FIG. 11F illustrates a screen when the product information has been entered by the user.

FIG. 11G illustrates a user profile screen. As shown in the figure, the user profile can also include one or more credentials, which are given to denote special qualifications or status. The credentials and corresponding verification criteria can include:

| Credentials | Criteria |
|---|---|
| Admin Badge | Administration; Moderator |
| Food Scientist | Validated with Linkedin Profile, Bus Card, |
| | Web Presence, Certificate, Diploma . . . |
| Certified Nurtitionist | Validated with Linkedin Profile, Bus Card, |
| | Web Presence, Certificate, Diploma . . . |
| Food Safety Professional | Validated with Linkedin Profile, Bus Card, |
| | Web Presence, Certificate, Diploma . . . |
| Science PhDs | Validated with Linkedin Profile, Bus Card, |
| | Web Presence, Certificate, Diploma . . . |
| Higher Ed Science Faculty/ | Validated with Linkedin Profile, Bus Card, |
| Research Faculty (Cornell, | Web Presence, Certificate, Diploma . . . |
| UMass Amherst, NC State) | |
| Medical Doctor | Validated with Linkedin Profile, Bus Card, |
| | Web Presence, Certificate, Diploma . . . |
| Registered Nurse | Validated with Linkedin Profile, Bus Card, |
| | Web Presence, Certificate, Diploma . . . |
| Homeopathic Medical | Validated with Linkedin Profile, Bus Card, |
| Professional | Web Presence, Certificate, Diploma . . . |
| Farmer? | Validated with Linkedin Profile, Bus Card, |
| | Web Presence, Certificate, Diploma . . . |
| Food B logger | Validated with a Web Link |
| Celebrity | |

FIG. 11H illustrates a home page for the community group “Thai at Home.” FIG. 11I illustrates the home screen including updates and notifications displayed at the bottom border. FIG. 11J illustrates a page for browsing or selecting community groups. FIG. 11K illustrates the same page as 11J after a user has joined the “Thai at Home” group. Additionally, FIG. 11L illustrates threads in a community group with corresponding carrots.

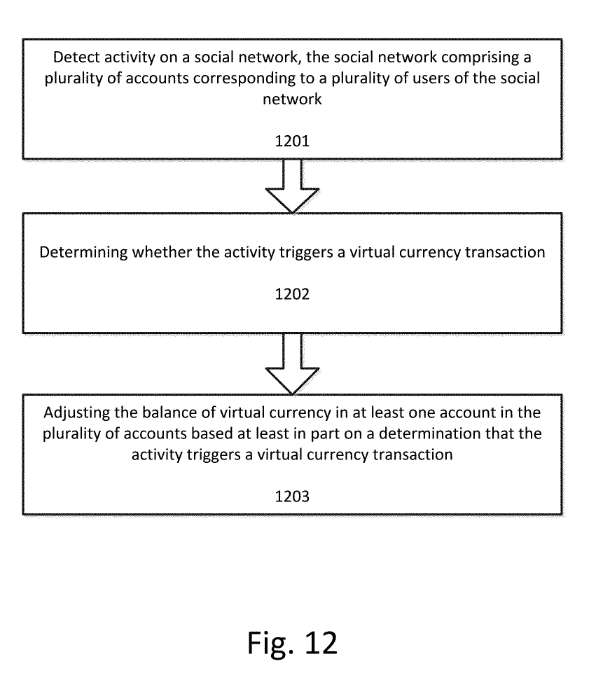

FIG. 12 illustrates a method for transferring virtual currency in a social network according to an exemplary embodiment.

At step 1201 activity is detected on the social network, the social network including a plurality of accounts corresponding to a plurality of users of the social network, each account in the plurality of accounts indicating a balance of virtual currency available to a corresponding user of the social network. The activity can be related to a first user in the plurality of users and the activity can include one or more of: initial registration of the first user with the social network; registration of a new user with the social network, the new user being referred by the first user; a daily login of the first user to the social network; creation of a new community group by the first user on the social network; creation of a new topic by the first user on the social network; an addition of a predetermined number of users of the social network to a community group created by the first user; responses from a predetermined number of users of the social network in a topic created by the first user; an addition to a first profile associated with the first user; an addition of a credential to the first profile associated with the first user; an addition by the first user of a predetermined number of products to a database of products in the social network; an addition by the first user of a predetermined number of photos of one or more products to the database of products in the social network; a correction by the first user to product data of a product in the database of products in the social network; or completion by the first user of one or more questions issued by a vendor of one or more products in the database of products in the social network.

At step 1202 it is determined whether the activity triggers a virtual currency transaction. This determination can be made by comparing the activity to a list of activities which trigger a virtual currency transaction, such as the ones shown in the table on earning carrots above.

The activity can include receiving an indication of approval from a first user in the plurality of users for a message posted on the social network, the indication of approval being associated with a quantity of virtual currency and the quantity of virtual currency being less than or equal to the balance of virtual currency in a first account corresponding to the first user.

At step 1203 the balance of virtual currency in at least one account in the plurality of accounts is adjusted based at least in part on a determination that the activity triggers a virtual currency transaction. Adjusting the balance of virtual currency in at least one account in the plurality of accounts based at least in part on the detected action can include one or more of: transferring the quantity of virtual currency over the social network from the first account of the first user to a second account of a second user, wherein the second user comprises an author of the message posted on the social network; depositing a second quantity of currency into a third account of a third user of the social network, wherein the third user comprises a creator of the topic on the social network and wherein the second quantity comprises a predetermined percentage of the first quantity; or depositing a third quantity of currency into a fourth account of a fourth user of the social network, wherein the fourth user comprises a creator of the community group on the social network and wherein the third quantity comprises a predetermined percentage of the first quantity.

Adjusting the balance of virtual currency in at least one account in the plurality of accounts based at least in part on the detected action can also include depositing a predetermined quantity of virtual currency into a first account corresponding to the first user.

The method can also include transforming metadata associated with the message to increment a count of virtual currency associated with the message by the quantity of virtual currency in the indication of approval, the social network being configured to rank one or more messages posted on the social network based at least in part on a quantity of virtual currency associated with each message in the one or more messages. The method can further include transforming metadata associated with the message to include a timestamp associated with the indication of approval, the social network being configured to rank the one or more messages posted on the social network based at least in part on a quantity of virtual currency associated with each message in the one or more messages and one or more timestamps associated with each message in the one or more messages. The method described with respect to FIG. 12 can be carried out using any of the techniques and features discussed with respect to FIGS. 1-11.

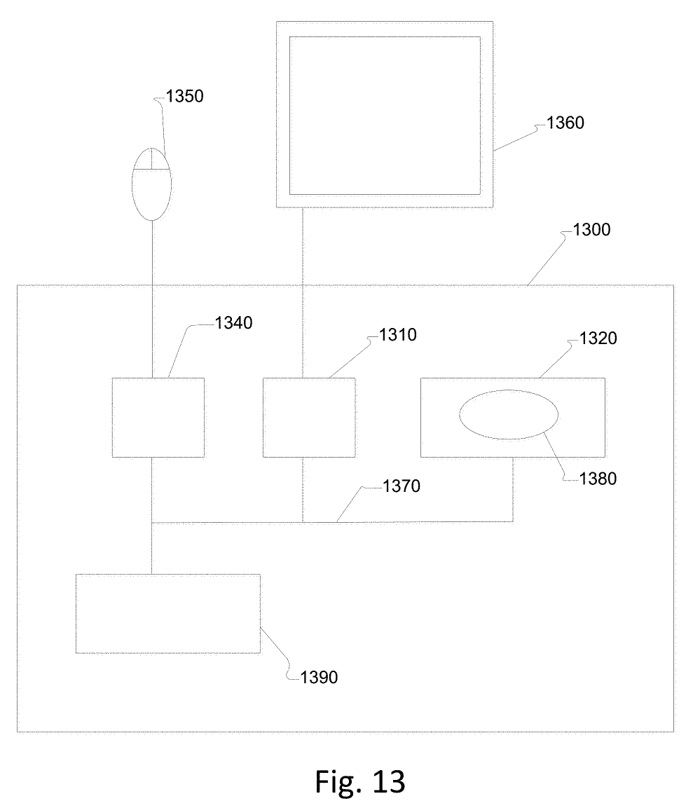

One or more of the above-described techniques can be implemented in or involve one or more computer systems. FIG. 13 illustrates a generalized example of a computing environment 900. The computing environment 1300 is not intended to suggest any limitation as to scope of use or functionality of a described embodiment.

With reference to FIG. 13, the computing environment 1300 can be a mobile device and includes at least one processing unit 1310 and memory 1320. The processing unit 1310 executes computer-executable instructions and may be a real or a virtual processor. In a multi-processing system, multiple processing units execute computer-executable instructions to increase processing power. The memory 1320 may be volatile memory (e.g., registers, cache, RAM), non-volatile memory (e.g., ROM, EEPROM, flash memory, etc.), or some combination of the two. The memory 1320 may store software instructions 1380 for implementing the described techniques when executed by one or more processors. Memory 1320 can be one memory device or multiple memory devices.

A computing environment may have additional features. For example, the computing environment 1300 includes storage 1340, one or more input devices 1350, one or more output devices 1360, and one or more communication connections 1390. An interconnection mechanism 1370, such as a bus, controller, or network interconnects the components of the computing environment 1300. Typically, operating system software or firmware (not shown) provides an operating environment for other software executing in the computing environment 1300, and coordinates activities of the components of the computing environment 1300.

The storage 1340 may be removable or non-removable, and includes magnetic disks, magnetic tapes or cassettes, CD-ROMs, CD-RWs, DVDs, or any other medium which can be used to store information and which can be accessed within the computing environment 1300. The storage 1340 may store instructions for the software 1380.

The input device(s) 1350 may be a touch input device such as a keyboard, mouse, pen, trackball, touch screen, or game controller, a voice input device, a scanning device, a digital camera, remote control, or another device that provides input to the computing environment 1300. The output device(s) 1360 may be a display, television, monitor, printer, speaker, or another device that provides output from the computing environment 1300.

The communication connection(s) 1390 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 1300, computer-readable media include memory 1320, storage 1340, communication media, and combinations of any of the above.

Of course, FIG. 13 illustrates computing environment 1300, display device 1360, and input device 1350 as separate devices for ease of identification only. Computing environment 1300, display device 1360, and input device 1350 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 1300 may be a set-top box, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method executed by one or more computing devices for ranking messages in a social network based on a virtual currency, the method comprising:
receiving, by at least one of the one or more computing devices, an indication of approval over the social network for a message posted on the social network from a first user of the social network, wherein the indication of approval is associated with a quantity of virtual currency and wherein the quantity of virtual currency is less than or equal to a balance of virtual currency in a first account of the first user on the social network;
transforming metadata associated with the message to increment a count of virtual currency associated with the message by the quantity of virtual currency associated with the indication of approval, wherein the social network is configured to rank one or more messages posted on the social network based at least in part on a quantity of virtual currency associated with each message in the one or more messages; and
removing the quantity of virtual currency from the first account of the first user.

2. The method of claim 1, further comprising:
transferring, by at least one of the one or more computing devices, the quantity of virtual currency over the social network to a second account of a second user of the social network, wherein the second user comprises an author of the message posted on the social network.

3. The method of claim 2, wherein the topic is associated with a community group of the social network, and further comprising:
depositing, by at least one of the one or more computing devices, a second quantity of currency into a third account of a third user of the social network, wherein the third user comprises a creator of the community group on the social network and wherein the second quantity comprises a predetermined percentage of the first quantity.

4. The method of claim 1, further comprising:
depositing, by at least one of the one or more computing devices, a second quantity of currency into the first account based at least in part on detection of activity associated with the first user.

5. The method of claim 4, wherein the activity comprises one or more of:
initial registration of the first user with the social network;
registration of a new user with the social network, the new user being referred by the first user;
a daily login of the first user to the social network;
creation of a new community group by the first user on the social network;
creation of a new topic by the first user on the social network;
an addition of a predetermined number of users of the social network to a community group created by the first user;
responses from a predetermined number of users of the social network in a topic created by the first user;
an addition to a first profile associated with the first user; or
an addition of a credential to the first profile associated with the first user.

6. The method of claim 4, wherein the social network includes a database of products and wherein the activity comprises one or more of:
an addition by the first user of a predetermined number of products to the database of products;
an addition by the first user of a predetermined number of photos of one or more products to the database of products;
a correction by the first user to product data of a product in the database of products; or
completion by the first user of one or more questions issued by a vendor of one or more products in the database of products.

7. The method of claim 1, further comprising:
transforming, by at least one of the one or more computing devices, metadata associated with the message to include a timestamp associated with the indication of approval, wherein the social network is configured to rank the one or more messages posted on the social network based at least in part on a quantity of virtual currency associated with each message in the one or more messages and one or more timestamps associated with each message in the one or more messages.

8. An apparatus for ranking messages in a social network based on a virtual currency, the apparatus comprising:
one or more processors; and
one or more memories operatively coupled to at least one of the one or more processors and having instructions stored thereon that, when executed by at least one of the one or more processors, cause at least one of the one or more processors to:
receive an indication of approval over the social network for a message posted on the social network from a first user of the social network, wherein the indication of approval is associated with a quantity of virtual currency and wherein the quantity of virtual currency is less than or equal to a balance of virtual currency in a first account of the first user on the social network;
transform metadata associated with the message to increment a count of virtual currency associated with the message by the quantity of virtual currency associated with the indication of approval, wherein the social network is configured to rank one or more messages posted on the social network based at least in part on a quantity of virtual currency associated with each message in the one or more messages; and
remove the quantity of virtual currency from the first account of the first user.

9. The apparatus of claim 8, wherein at least one of the one or more memories has further instructions stored thereon that, when executed by at least one of the one or more processors, cause at least one of the one or more processors to:
transfer the quantity of virtual currency over the social network to a second account of a second user of the social network, wherein the second user comprises an author of the message posted on the social network.

10. The apparatus of claim 9, wherein the topic is associated with a community group of the social network, and wherein at least one of the one or more memories has further instructions stored thereon that, when executed by at least one of the one or more processors, cause at least one of the one or more processors to:
deposit a second quantity of currency into a third account of a third user of the social network, wherein the third user comprises a creator of the community group on the social network and wherein the second quantity comprises a predetermined percentage of the first quantity.

11. The apparatus of claim 8, wherein at least one of the one or more memories has further instructions stored thereon that, when executed by at least one of the one or more processors, cause at least one of the one or more processors to:
deposit a second quantity of currency into the first account based at least in part on detection of activity associated with the first user.

12. The apparatus of claim 11, wherein the social network includes a database of products and wherein the activity comprises one or more of:
an addition by the first user of a predetermined number of products to the database of products;
an addition by the first user of a predetermined number of photos of one or more products to the database of products;
a correction by the first user to product data of a product in the database of products; or
completion by the first user of one or more questions issued by a vendor of one or more products in the database of products.

13. The apparatus of claim 8, wherein at least one of the one or more memories has further instructions stored thereon that, when executed by at least one of the one or more processors, cause at least one of the one or more processors to:
transform metadata associated with the message to include a timestamp associated with the indication of approval, wherein the social network is configured to rank the one or more messages posted on the social network based at least in part on a quantity of virtual currency associated with each message in the one or more messages and one or more timestamps associated with each message in the one or more messages.

14. At least one non-transitory computer-readable medium storing computer-readable instructions that, when executed by one or more computing devices, cause at least one of the one or more computing devices to:
receive an indication of approval over the social network for a message posted on the social network from a first user of the social network, wherein the indication of approval is associated with a quantity of virtual currency and wherein the quantity of virtual currency is less than or equal to a balance of virtual currency in a first account of the first user on the social network;
transform metadata associated with the message to increment a count of virtual currency associated with the message by the quantity of virtual currency associated with the indication of approval, wherein the social network is configured to rank one or more messages posted on the social network based at least in part on a quantity of virtual currency associated with each message in the one or more messages; and
remove the quantity of virtual currency from the first account of the first user.

15. The at least one non-transitory computer-readable medium of claim 14, further storing computer-readable instructions that, when executed by at least one of the one or more computing devices, cause at least one of the one or more computing devices to:
transfer the quantity of virtual currency over the social network to a second account of a second user of the social network, wherein the second user comprises an author of the message posted on the social network.

16. The at least one non-transitory computer-readable medium of claim 15, wherein the topic is associated with a community group of the social network, and further storing computer-readable instructions that, when executed by at least one of the one or more computing devices, cause at least one of the one or more computing devices to:
deposit a second quantity of currency into a third account of a third user of the social network, wherein the third user comprises a creator of the community group on the social network and wherein the second quantity comprises a predetermined percentage of the first quantity.

17. The at least one non-transitory computer-readable medium of claim 14, further storing computer-readable instructions that, when executed by at least one of the one or more computing devices, cause at least one of the one or more computing devices to:
deposit a second quantity of currency into the first account based at least in part on detection of activity associated with the first user.

18. The at least one non-transitory computer-readable medium of claim 17, wherein the social network includes a database of products and wherein the activity comprises one or more of:
an addition by the first user of a predetermined number of products to the database of products;
an addition by the first user of a predetermined number of photos of one or more products to the database of products;
a correction by the first user to product data of a product in the database of products; or
completion by the first user of one or more questions issued by a vendor of one or more products in the database of products.

19. The at least one non-transitory computer-readable medium of claim 14, further storing computer-readable instructions that, when executed by at least one of the one or more computing devices, cause at least one of the one or more computing devices to:
transform metadata associated with the message to include a timestamp associated with the indication of approval, wherein the social network is configured to rank the one or more messages posted on the social network based at least in part on a quantity of virtual currency associated with each message in the one or more messages and one or more timestamps associated with each message in the one or more messages.
